(19) United States
(12) Patent Application Publication
(10) Pub. No.: US 2022/0095054 A1
(43) Pub. Date: Mar. 24, 2022

(54) SOUND OUTPUT APPARATUS AND SOUND OUTPUT METHOD

(71) Applicant: Sony Group Corporation, Tokyo (JP)

(72) Inventor: Michiaki Yoneda, Kanagawa (KR)

(73) Assignee: Sony Group Corporation, Tokyo (JP)

(21) Appl. No.: 17/420,361

(22) PCT Filed: Nov. 15, 2019
(86) PCT No.: PCT/JP2019/044877

§ 371 Date: Jul. 1, 2021

(30) Foreign Application Priority Data
Jan. 9, 2019 (JP) 2019-001731

(51) Int. Cl. H04R 7/04; G06F 1/16; G10K 9/12; H04N 5/64; H04R 3/12; G06F 3/16

(52) U.S. Cl. CPC H04R 7/045; G06F 1/1605; G10K 9/12; H04S 7/301; H04R 3/12; G06F 3/16; H04N 5/642

(57) ABSTRACT

A sound output apparatus includes a display panel for displaying video content; one or more first sound output driving units for vibrating the display panel on the basis of a first sound signal which is a sound signal of the video content displayed on the display panel and for executing sound reproduction; a plurality of second sound output driving units for vibrating the display panel on the basis of a second sound signal different from the first sound signal and for executing the sound reproduction; and a localization processing unit for setting a constant location of a sound output by the plurality of second sound output driving units by signal processing of the second sound signal.

### TECHNICAL FIELD

The present technology relates to a sound output apparatus and a sound output method, and more particularly, to a technical field of a sound output performing together with a video display.

### BACKGROUND ART

For example, in a video output device such as a television apparatus, while outputting a sound associated with video content from a speaker, there is a case where other sound is also output to the speaker. In recent years, there has been known a system which performs a response corresponding to an inquiry by a sound of a user. Also, an input/output function of such a system is built in the television apparatus such that a response sound is output to the user during viewing and hearing of the video content.

Patent Literature 1 discloses a technique relating to signal processing for a virtual sound source location reproduction as a technique relating to a sound output by a speaker.

### CITATION LIST

### Patent Literature

Patent Literature 1: Japanese Patent Application Laid-open No. 2015-211418

### DISCLOSURE OF INVENTION

### Technical Problem

Incidentally, when a user is viewing and hearing video content by a television apparatus, a sound of the video content is naturally output, but if the above-described system for responding is mounted, the response sound corresponding to the user making an inquiry is also output from the same speaker as the content sound.

In this case, the content sound and the response sound are heard together, and the situation which is difficult for the user to hear occurs.

Therefore, an object of the present technology is to make it easier for a user to hear when outputting other sounds together with the content sound.

### Solution to Problem

A sound output apparatus according to the present technology includes a display panel for displaying video content; one or more first sound output driving units for vibrating the display panel on the basis of a first sound signal which is a sound signal of the video content displayed on the display panel and for executing sound reproduction; a plurality of second sound output driving units for vibrating the display panel on the basis of a second sound signal different from the first sound signal and for executing the sound reproduction; and a localization processing unit for setting a constant location of a sound output by the plurality of second sound output driving units by signal processing of the second sound signal.

For example, in a device having the display panel, such as a television apparatus, the sound output is performed by vibrating the display panel. The first sound signal is a sound corresponding to the video to be displayed. In this case, there are provided the second sound output driving units for outputting the sound by the second sound signal which is not the sound of the video content being displayed.

In the sound output apparatus according to the present technology described above, it is conceivable that the display panel is divided into a plurality of vibration regions that vibrate independently, and the sound output driving units that are the first sound output driving units or the second sound output driving units are arranged one by one for each vibration region.

That is, the plurality of vibration regions are provided on an entire surface or a part of the surface of one display panel. In this case, one vibration region corresponds to one sound output driving unit.

In the sound output apparatus according to the present technology described above, it is conceivable that the second sound signal is a sound signal of a response sound generated corresponding to a request.

For example, it is the response sound (sound of answer to a question, etc.) generated corresponding to the request by the sound or the like input by the user as an agent apparatus.

In the sound output apparatus according to the present technology described above, it is conceivable that the localization processing unit performs localization processing for localizing the sound by the second sound signal to a location outside a display surface range of the display panel.

That is, for the user, the sound by the second sound signal is heard from a location other than the display surface on which the video display is performed.

In the sound output apparatus according to the present technology described above, it is conceivable that specific sound output driving units among the plurality of sound output driving units arranged on the display panel are the second sound output driving units.

That is, the specific sound output driving units are assigned as the second sound output driving units.

In the sound output apparatus according to the present technology described above, it is conceivable that the display panel is divided into a plurality of vibration regions that vibrate independently, and that the second sound output driving units are arranged on the vibration regions other than each vibration region including a center of the display panel.

The plurality of vibration regions are provided on an entire surface or a part of the surface of one display panel. In this case, one sound output driving unit corresponds to one vibration region.

In the sound output apparatus according to the present technology described above, it is conceivable that the display panel is divided into a plurality of vibration regions that vibrate independently, and the respective second sound output driving units are arranged on two vibration regions at least located in the left and right directions of the display panel.

That is, the two vibration regions arranged so as to be at least a left-right positional relationship are driven by the respective second sound output driving units.

In the sound output apparatus according to the present technology described above, it is conceivable that the display panel is divided into a plurality of vibration regions that vibrate independently, and the respective second sound output driving units are arranged on two vibration regions at least located in the up and down directions of the display panel.

That is, the two vibration regions arranged so as to be at least an up-down positional relationship are driven by the respective second sound output driving units.

In the sound output apparatus according to the present technology described above, it is conceivable that the display panel is divided into a plurality of vibration regions that vibrate independently, a sound output driving unit is provided for each vibration region, in a case where a sound output based on the second sound signal is not performed, all the sound output driving units are used as the first sound output driving units, and in a case where the sound output based on the second sound signal is performed, parts of the sound output driving units are used as the second sound output driving units.

The plurality of vibration regions are provided on an entire surface or a part of the surface of one display panel, and each sound output driving unit corresponds to each of them. In this case, some of the sound output driving units are switched and used between an output application of the first sound signal and an output application of the second sound signal.

In the sound output apparatus according to the present technology described above, it is conceivable that the sound output driving units on the vibration regions other than each vibration region including a center of the display panel are the parts of the sound output driving units.

The plurality of vibration regions are provided on an entire surface or a part of the surface of one display panel. In this case, one sound output driving unit corresponds to one vibration region.

In the sound output apparatus according to the present technology described above, it is conceivable that in a case where a reproduced sound by the second sound signal is output, processing of selecting the sound output driving units used as the second sound output driving units is performed.

That is, among a plurality of sets of the vibration region and the sound output driving unit, the vibration region and the sound output driving unit to be used by switching for outputting the second sound signal is selected without fixing.

In the sound output apparatus according to the present technology described above, it is conceivable that in a case where the reproduced sound by the second sound signal is output, a sound output level is detected by the plurality of sound output driving units, and the sound output driving units used as the second sound output driving units are selected depending on the output level of each sound output driving unit.

That is, among the plurality of sets of the vibration region and the sound output driving unit, the vibration region and the sound output driving unit to be used by switching for outputting the second sound signal are selected depending on the output status at that time.

In the sound output apparatus according to the present technology described above, it is conceivable that the sound output driving units on the vibration regions other than each vibration region including a center of the display panel detect the sound output level and select the sound output driving units to be used as the second sound output driving units depending on the detected output level.

For example, for each output opportunity of the second sound signal, among the sets of the vibration region and the sound output driving unit other than the center of the display screen, a set for switching to the sound output for the second sound signal is selected depending on each output level.

It is conceivable that the sound output apparatus according to the present technology described above is a built-in television apparatus.

That is, the present technology is employed in a case where the sound reproduction is performed using the display panel of the television apparatus.

A sound output method according to the present technology includes executing sound reproduction by vibrating a display panel with one or more first sound output driving units on the basis of a first sound signal which is a sound signal of video content to be displayed on the display panel for displaying the video content, performing signal processing for setting a constant location on a second sound signal different from the first sound signal, and executing sound reproduction by vibrating the display panel by a plurality of second sound output driving units for the second sound signal.

Thus, the second sound signal is output at a predetermined constant location by a sound output driving unit different from the sound output driving unit of the sound signal of the video content.

### BRIEF DESCRIPTION OF DRAWINGS

FIG. 1 is an explanatory diagram of a system configuration example according to an embodiment of the present technology.

FIG. 2 is an explanatory diagram of another system configuration example according to the embodiment.

FIG. 3 is a block diagram of a configuration example of a television apparatus according to the embodiment.

FIG. 4 is a block diagram of another configuration example of a television apparatus according to the embodiment.

FIG. 5 is a block diagram of a computer apparatus according to the embodiment.

FIG. 6 is an explanatory diagram of a side configuration of the television apparatus according to the embodiment.

FIG. 7 is an explanatory diagram of a rear configuration of a display panel according to the embodiment.

FIG. 8 is an explanatory diagram of the rear configuration with removing the rear cover of the display panel according to the embodiment.

FIG. 9 is a B-B sectional view of the display panel according to the embodiment.

FIG. 10 is an explanatory diagram of a vibration region of the display panel according to the embodiment.

FIG. 11 is an explanatory diagram of a sound output system according to a comparative example.

FIG. 12 is a block diagram of a sound output apparatus according to a first embodiment.

FIG. 13 is an explanatory diagram of a sound output state according to the first embodiment.

FIG. 14 is an explanatory diagram of a vibration region and an actuator arrangement example according to the first embodiment.

FIG. 15 is a block diagram of a sound output apparatus according to a second embodiment.

FIG. 16 is an explanatory diagram of a vibration region and an actuator arrangement example according to the second embodiment.

FIG. 17 is an explanatory diagram of a vibration region and an actuator arrangement example according to a third embodiment.

FIG. 18 is a block diagram of a sound output apparatus according to a fourth embodiment.

FIG. 19 is an explanatory diagram of a vibration region and an actuator arrangement example according to the fourth embodiment.

FIG. 20 is an explanatory diagram of a vibration region and an actuator arrangement example according to a fifth embodiment.

FIG. 21 is an explanatory diagram of a vibration region and an actuator arrangement example according to a sixth embodiment.

FIG. 22 is an explanatory diagram of a vibration region and an actuator arrangement example according to the embodiment.

FIG. 23 is a block diagram of a sound output apparatus according to a seventh embodiment.

FIG. 24 is a circuit diagram of a channel selection unit according to the seventh embodiment.

FIG. 25 is an explanatory diagram of a vibration region and an actuator selection example according to the seventh embodiment.

FIG. 26 is an explanatory diagram of the vibration region and the actuator selection example according to the seventh embodiment.

FIG. 27 is a block diagram of a sound output apparatus according to an eighth embodiment.

FIG. 28 is a circuit diagram of a channel selection unit according to the eighth embodiment.

FIG. 29 is an explanatory diagram of a vibration region and an actuator selection example according to the eighth embodiment.

FIG. 30 is a flowchart of a selection processing example according to a ninth embodiment.

FIG. 31 is a flowchart of a selection processing example according to a tenth embodiment.

### MODE(S) FOR CARRYING OUT THE INVENTION

Hereinafter, embodiments will be described in the following order.
<1. System configuration example>
<2. Configuration example of television apparatus>
<3. Display panel configuration>
<4. Comparative example>
<5. First embodiment>
<6. Second embodiment>
<7. Third embodiment>
<8. Fourth embodiment>
<9. Fifth embodiment>
<10. Sixth embodiment>
<11. Seventh embodiment>
<12. Eighth embodiment>
<13. Ninth embodiment>
<14. Tenth embodiment>
<15. Summary and modifications>

### 1. System Configuration Example

First, a system configuration example including a television apparatus 2 having an agent apparatus 1 will be described as an embodiment.

Note that the agent apparatus 1 in this embodiment includes an information processing apparatus that outputs a response sound corresponding to a request of a sound of the user or the like, and transmits an operation instruction to various electronic devices depending on an instruction of the user or a situation.

In particular, in the case of this embodiment, an example is given in which the agent apparatus 1 is built in the television apparatus 2, but the agent apparatus 1 outputs the response sound by using a speaker of the television apparatus 2 depending on the sound of the user picked up by a microphone.

Note that the agent apparatus 1 is not necessarily built in the television apparatus 2, and may be a separate apparatus.

In addition, the television apparatus 2 described in the embodiment is an example of an output device that outputs a video and a sound, and in particular, an example of a device that includes a sound output apparatus and is capable of outputting a content sound and an agent sound.

The content sound is a sound accompanying video content output by the television apparatus 2, and the agent sound refers to a sound such as a response to the user by the agent apparatus 1.

Incidentally, it is an example that a device provided with the sound output apparatus is the television apparatus 2, and various apparatuses such as an audio apparatus, an interactive apparatus, a robot, a personal computer apparatus, and a terminal apparatus, are assumed to be sound output apparatuses that cooperate with the agent apparatus 1. The operation of the television apparatus 2 in the description of the embodiment can be similarly applied to these various output devices.

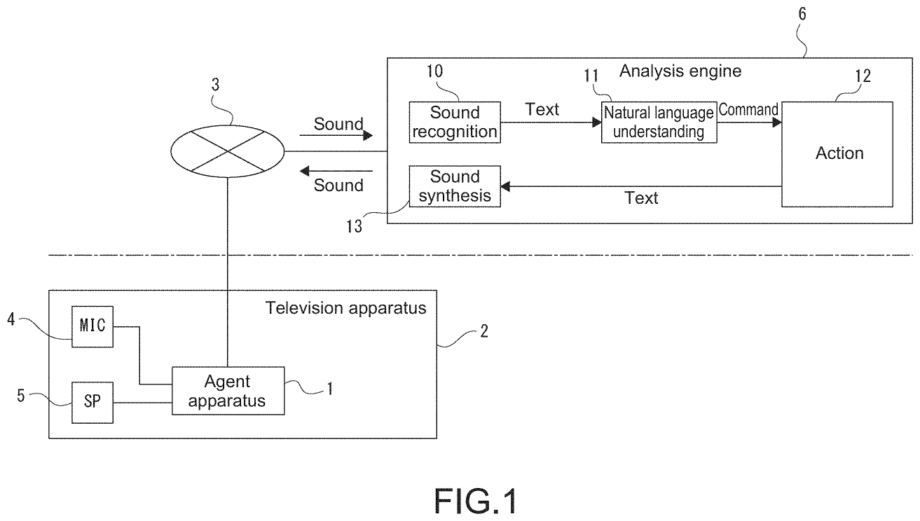

FIG. 1 shows a system configuration example including the television apparatus 2 including the agent apparatus 1.

The agent apparatus 1 is built in the television apparatus 2 and inputs a sound by a microphone 4 attached to the television apparatus 2, for example.

In addition, the agent apparatus 1 is capable of communicating with an external analysis engine 6 via a network 3.

In addition, the agent apparatus 1 outputs the sound by using, for example, a speaker 5 included in the television apparatus 2.

That is, the agent apparatus 1 includes, for example, software having a function of recording the sound of the user input from the microphone 4, a function of reproducing the response sound using the speaker 5, and a function of exchanging with the analysis engine 6 as a cloud server via the network 3.

The network 3 may be a transmission path in which the agent apparatus 1 is capable of communicating with an external device of the system, and various forms such as the Internet, a LAN (Local Area Network), a VPN (Virtual Private Network), an intranet, an extranet, a satellite communication network, a CATV (Community Antenna TeleVision) communication network, a telephone line network, a mobile communication network, and the like are assumed.

Thus, in a case where it is capable of communicating with the external analysis engine 6, the agent apparatus 1 can cause the analysis engine 6 to execute necessary analysis processing.

The analysis engine 6 is, for example, an AI (artificial intelligence) engine, and can transmit appropriate information to the agent apparatus 1 on the basis of input data for analysis.

For example, the analysis engine 6 includes a sound recognition unit 10, a natural language understanding unit 11, an action unit 12, and a sound synthesis unit 13 as processing functions.

The agent apparatus 1 transmits a sound signal based on the sound of the user input from the microphone 4, for example, to the analysis engine 6 via the network 3.

In the analysis engine 6, the sound recognition unit 10 recognizes the sound signal transmitted from the agent apparatus 1, and converts the sound signal into text data. Language analysis is performed on the text data by the natural language understanding unit 11, and a command is extracted from the text, and an instruction corresponding to command content is transmitted to the action unit 12. The action unit 12 performs an action corresponding to the command.

For example, if the command is an inquiry such as tomorrow's weather, a result (e.g., “tomorrow's weather is fine”, etc.) is generated as the text data. The text data is converted into the sound signal by the sound synthesis unit 13 and transmitted to the agent apparatus 1.

Upon receiving the sound signal, the agent apparatus 1 supplies the sound signal to the speaker 5 to execute a sound output. Thus, a response to the sound uttered by the user is output.

Note that as a timing of transmitting the sound signal of the command of the agent apparatus 1 to the analysis engine 6, for example, there is a method in which the agent apparatus 1 always records the sound from the microphone 4 and transmits the sound of the subsequent command to the analysis engine 6 when the sound matches a keyword to be activated. Alternatively, after the switch is turned on by hardware or software, the sound of the command issued by the user may be transmitted to the analysis engine 6.

In addition, the agent apparatus 1 may be configured to accept not only an input by the microphone 4 but also an input by various sensing devices and perform corresponding processing. For example, as the sensing device, an imaging apparatus (camera), a contact sensor, a load sensor, an illuminance sensor, an IR sensor, an acceleration sensor, an angular speed sensor, a laser sensor, and all other sensors are assumed. The sensing device may be built in the agent apparatus 1 and the television apparatus 2, or may be a separate device from the agent apparatus 1 and the television apparatus 2.

In addition, the agent apparatus 1 may not only output the response sound to the user but also perform a device control depending on a command of the user. For example, depending on an instruction by the sound of the user (or instruction detected by other sensing device), it is also possible to perform an output setting of a video and a sound of the television apparatus 2. A setting relating to a video output is a setting that causes a change in the video output, such as a brightness setting, a color setting, sharpness, a contrast, a noise reduction, and the like. A setting relating to the sound output is a setting in which a change of the sound output occurs, and is a setting of a volume level and a setting of a sound quality. The setting of the sound quality includes, for example, low-frequency enhancement, high-frequency enhancement, equalizing, noise cancellation, reverb, echo, etc.

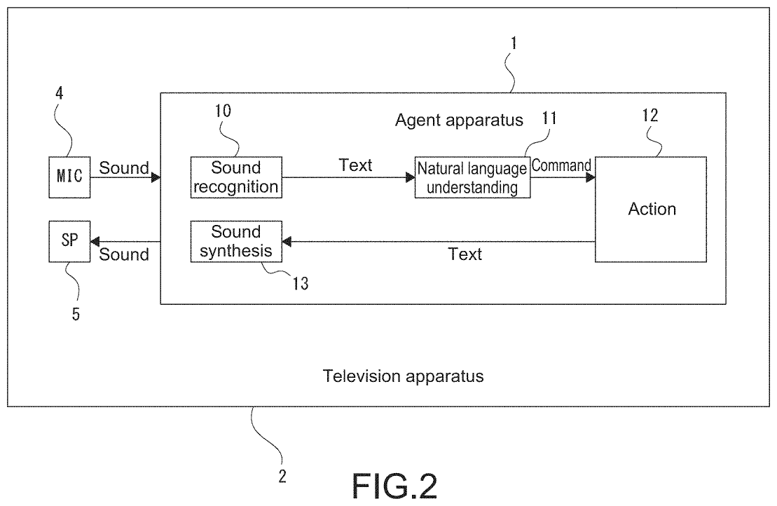

FIG. 2 shows another configuration example. This is an example in which the agent apparatus 1 built in the television apparatus 2 has a function as the analysis engine 6.

For example, the agent apparatus 1 recognizes the sound of the user input from the microphone 4 by the sound recognition unit 10 and converts the sound into the text data. The language analysis is performed on the text data by the natural language understanding unit 11, the command is extracted from the text, and the instruction corresponding to the command content is transmitted to the action unit 12. The action unit 12 performs an action corresponding to the command. The action unit 12 generates the text data as the response, and the text data is converted into the sound signal by the sound synthesis unit 13. The agent apparatus 1 supplies the sound signal to the speaker 5 to execute the sound output.

### 2. Configuration Example of Television Apparatus

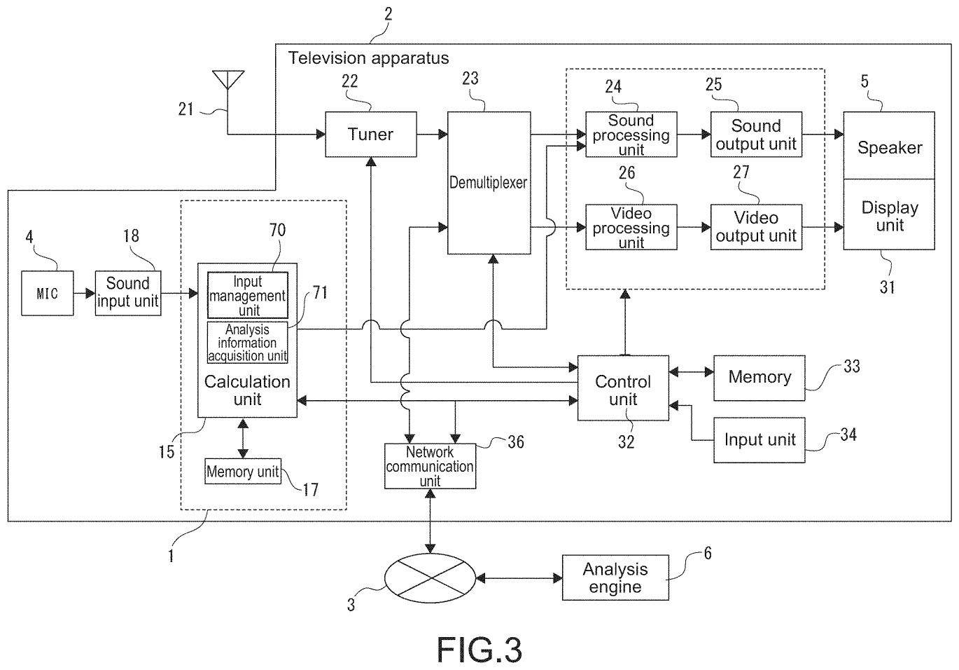

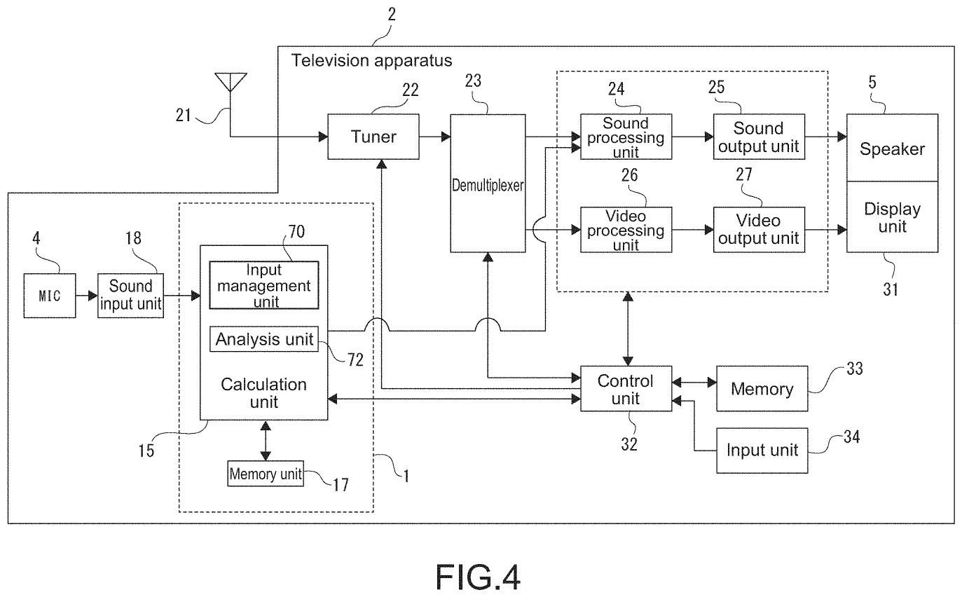

Hereinafter, FIG. 3 shows a configuration example of the television apparatus 2 corresponding to the system configuration of FIG. 1, and FIG. 4 shows a configuration example of the television apparatus 2 corresponding to the system configuration of FIG. 2.

First, referring to FIG. 3, the configuration example using the external analysis engine 6 will be described.

The agent apparatus 1 built in the television apparatus 2 includes a calculation unit 15 and a memory unit 17.

The calculation unit 15 includes the information processing apparatus such as a microcomputer, for example.

The calculation unit 15 has functions as an input management unit 70 and an analysis information acquisition unit 71. These functions may be performed, for example, by software which defines processing of the microcomputer or the like. On the basis of these functions, the calculation unit 15 executes necessary processing.

The memory unit 17 provides a work area necessary for the calculation processing by the calculation unit 15 and stores a coefficient, data, a table, a database, and the like used for the calculation processing.

The sound of the user is picked up by the microphone 4 and is output as the sound signal. The sound signal obtained by the microphone 4 is subjected to amplification processing or filtering processing, further A/D conversion processing or the like by the sound input unit 18 and is supplied to the calculation unit 15 as a digital sound signal.

The calculation unit 15 acquires the sound signal by a function of the input management unit 70, and determines whether or not the information is to be transmitted to the analysis engine 6.

In a case where the sound signal to be transmitted for analysis is acquired, the calculation unit 15 performs processing for acquiring the response by the function of the analysis information acquisition unit 71. That is, the calculation unit 15 (analysis information acquisition unit 71) transmits the sound signal to the analysis engine 6 via the network 3 by the network communication unit 36.

The analysis engine 6 performs the necessary analysis processing as described in FIG. 1, and transmits the resulting sound signal to the agent apparatus 1. The calculation unit 15 (analysis information acquiring unit 71) acquires the sound signal transmitted from the analysis engine 6 and transmits the sound signal to the sound processing unit 24 in order to output the sound signal from the speaker 5 as the sound.

The television apparatus 2 supplies a demodulated signal of the video content obtained by receiving and demodulating by the tuner 22 a broadcast wave received by the antenna 21 to the demultiplexer 23.

The demultiplexer 23 supplies the sound signal in the demodulated signal to the sound processing unit 24, and supplies the video signal to the video processing unit 26.

Also, in a case where the video content as a streaming video, for example, is received from a content server (not shown) via the network 3, the demultiplexer 23 supplies the sound signal of the video content to the sound processing unit 24 and supplies the video signal to the video processing unit 26.

The sound processing unit 24 decodes the input sound signal. In addition, the signal processing corresponding to various output settings is carried out for the sound signal obtained by decoding processing. For example, it performs a volume level adjustment, low-frequency enhancement processing, high-frequency enhancement processing, equalizing processing, noise cancellation processing, reverb processing, echo processing, etc. The sound processing unit 24 supplies the sound signal subjected to the processing to the sound output unit 25.

The sound output unit 25 D/A converts, for example, the supplied sound signal into an analog sound signal, performs amplification processing by a power amplifier or the like, and supplies it to the speaker 5. This results in the sound output of the video content.

In addition, in a case where the sound signal from the agent apparatus 1 is supplied to the sound processing unit 24, the sound signal is also output from the speaker 5.

Note that in the case of this embodiment, the speaker 5 is realized by a structure for vibrating a display panel itself of the television apparatus 2 as described later.

The video processing unit 26 decodes the video signal from the demodulated signal. In addition, the signal processing corresponding to various output settings is carried out for the video signal obtained by the decoding processing. For example, brightness processing, color processing, sharpness adjustment processing, contrast adjustment processing, noise reduction processing, etc. are performed. The video processing unit 26 supplies the video signal subjected to the processing to the video output unit 27.

The video output unit 27 performs display driving of the display unit 31 by, for example, the supplied video signal. As a result, the display output of the video content is performed in the display unit 31.

The control unit 32 is configured by, for example, the microcomputer or the like, and controls a receiving operation and an output operation of a video and a sound in the television apparatus 2.

The input unit 34 is, for example, an input unit for a user operation, and is configured as an operator and a reception unit of a remote controller.

The control unit 32 performs a reception setting of the tuner 22, an operation control of the demultiplexer 23, a setting control of the sound processing in the sound processing unit 24 and the sound output unit 25, a control of output setting processing of the video in the video processing unit 26 and the video output unit 27, and the like on the basis of user operation information from the input unit 34.

The memory 33 stores information necessary for the control of the control unit 32. For example, actual setting values corresponding to various video settings and sound settings are also stored in the memory 33, so that the control unit 32 can read out.

The control unit 32 is capable of communicating with the calculation unit 15 of the agent apparatus 1. As a result, it is possible to acquire information on video and sound output settings from the calculation unit 15.

By controlling the signal processing of the sound processing unit 24 and the video processing unit 26 corresponding to the output settings received by the control unit 32 from the agent apparatus 1, it realizes that the videos and the sounds are output corresponding to the output setting set by the agent apparatus 1 in the television apparatus 2.

Incidentally, the television apparatus 2 of FIG. 3 is a configuration example in which the broadcast wave is received by the antenna 21, but, needless to say, may be a television apparatus 2 corresponding to a cable television or an Internet broadcast, for example, may have an Internet browser function. FIG. 3 is an example of the television apparatus 2 as an output device for videos and sounds.

Next, FIG. 4 shows a configuration example corresponding to FIG. 2. However, the same parts as those in FIG. 3 are denoted by the same reference numerals, and description thereof is omitted.

FIG. 4 differs from FIG. 3 in that the agent apparatus 1 has a function as an analysis unit 72, and can generate the response sound without communicating with the external analysis engine 6.

The calculation unit 15 acquires the sound signal by the function as the input management unit 70, and if it is determined that the sound signal is to be corresponded, the calculation unit 15 performs the processing described with reference to FIG. 2 by the function of the analysis unit 72, and generates the sound signal as the response. Then, the sound signal is transmitted to the sound processing unit 24.

As a result, the speaker 5 outputs the response sound.

Incidentally, although the agent apparatus 1 built in the television apparatus 2 is exemplified in FIGS. 3 and 4, it also assumes the agent apparatus 1 that is separate from the television apparatus 2.

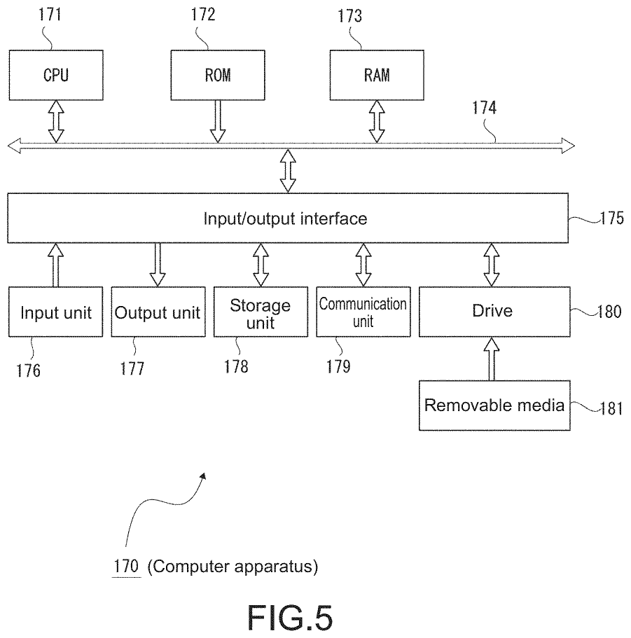

The built-in or separate agent apparatus 1 can be realized as a hardware configuration by a computer apparatus 170 as shown in FIG. 5, for example.

In FIG. 5, a CPU (Center Processing Unit) 171 of the computer apparatus 170 executes various kinds of processing corresponding to a program stored in a ROM (Read Only Memory) 172 or a program loaded from a storage unit 178 into a RAM (Random Access Memory) 173. The RAM 173 also stores, as appropriate, data necessary for the CPU 171 to perform the various kinds of processing.

The CPU 171, the ROM 172, and the RAM 173 are interconnected via a bus 174. An input/output interface 175 is also connected to the bus 174.

The input/output interface 175 is connected to an input unit 176 including a sensing device, an operator, and an operation device.

Furthermore, the input-output interface 175 may be connected to a display including an LCD (Liquid Crystal Display), an organic EL (Electro-Luminescence) panel, or the like as well as an output unit 177 including a speaker or the like.

The input/output interface 175 may be connected to the storage unit 178 including a hard disk or the like, or a communication unit 179 including a modem or the like.

The communication unit 179 performs communication processing via the transmission path such as the Internet shown as the network 3, and performs communication by wired/wireless communication, bus communication, or the like with the television apparatus 2.

The input/output interface 175 is also connected to a drive 180 as necessary, and a removable medium 181, e.g., a magnetic disk, an optical disk, a magneto-optical disk, or a semiconductor memory, is mounted, as appropriate, and a computer program read from them is installed in the storage unit 178, as necessary.

In a case where the functions of the calculation unit 15 described above are executed by software, a program included in the software may be installed from a network or a recording medium.

The recording medium includes the removable medium 181 including the magnetic disk, the optical disk, the magneto-optical disk, the semiconductor memory, or the like on which the program is recorded, which is distributed for delivering the program to the user. Alternatively, it may include the ROM 172 in which the program is recorded, or a hard disk included in the storage unit 178, which is distributed to the user in a state incorporated in a main body of the apparatus in advance.

In a case where such a computer apparatus 170 is the agent apparatus 1, the computer apparatus 170 inputs information of the sensing device as the input unit 176, the CPU 171 functions as the calculation unit 15 and can perform an operation of transmitting, for example, the sound signal or a control signal to the television apparatus 2 via the communication unit 179.

### 3. Display Panel Configuration

The speaker 5 in this embodiment has a structure in which a display surface of the television apparatus 2 is a vibration plate. A configuration of a video display surface 110A of the television apparatus 2 as a vibration unit 120 will be described below.

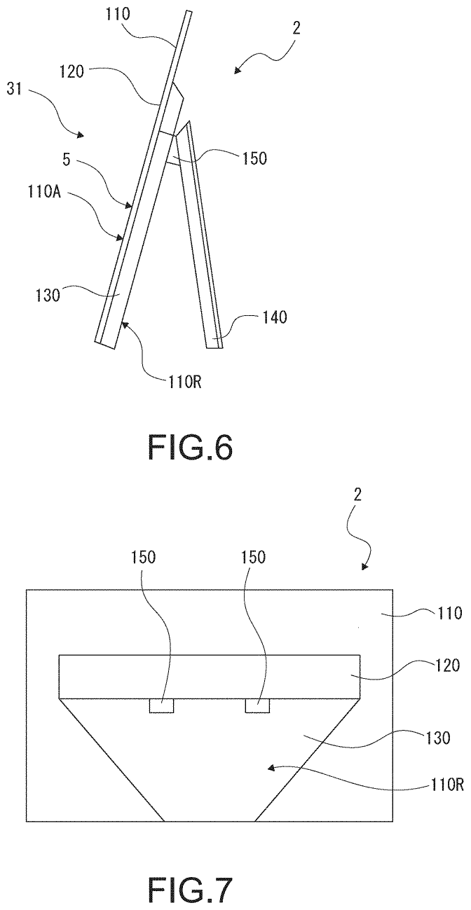

FIG. 6 shows a side configuration example of the television apparatus 2. FIG. 7 shows a rear surface configuration example of the television apparatus 2 of FIG. 6. The television apparatus 2 displays the video on the video display surface 110A and outputs the sound from the video display surface 110A. In other words, it can also be said that in the television apparatus 2, a flat panel speaker is built in the video display surface 110A.

The television apparatus 2 includes, for example, a panel unit 110 which displays the video and also functions as the vibration plate and the vibration unit 120 arranged on a back surface of the panel unit 110 for vibrating the panel unit 110.

The television apparatus 2 further includes, for example, a signal processing unit 130 for controlling the vibration unit 120 and a support member 140 that supports the panel unit 110 via each rotating member 150. The signal processing unit 130 includes, for example, a circuit board configuring all or a part of the sound output unit 25 described above.

Each rotating member 150 is for adjusting an inclination angle of the panel unit 110 when supporting the rear surface of the panel unit 110 by the support member 140, and, for example, is configured by a hinge for rotatably supporting the panel unit 110 and the support member 140.

The vibration unit 120 and the signal processing unit 130 are arranged on the back surface of the panel unit 110. The panel unit 110, on a back side thereof, has a rear cover 110R for protecting the panel unit 110, the vibration unit 120, and the signal processing unit 130. The rear cover 110R is formed of, for example, a plate-like metallic plate or a resin plate. The rear cover 110R is connected to each rotating member 150.

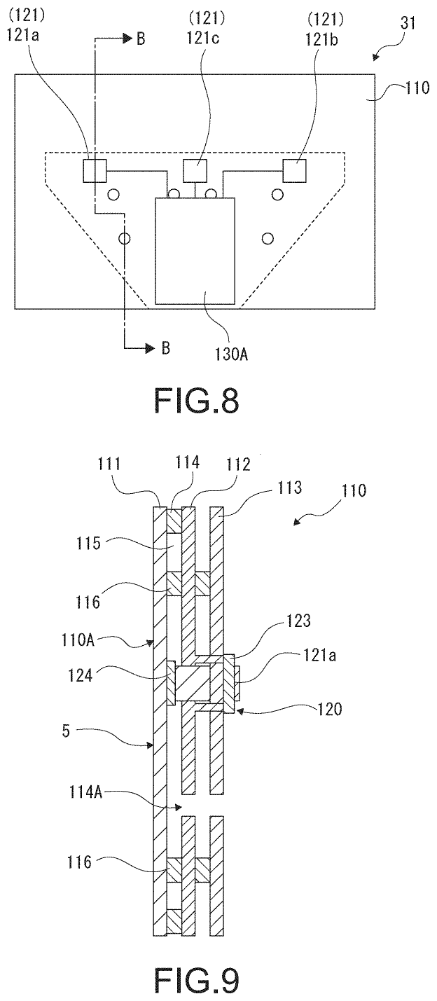

FIG. 8 shows a configuration example of the rear surface of the television apparatus 2 when the rear cover 110R is removed. The circuit board 130A corresponds to a specific example of the signal processor 130.

FIG. 9 shows a cross-sectional configuration example taken along a line B-B in FIG. 8. FIG. 9 shows a cross-sectional configuration of an actuator (vibrator) 121a, which will be described later, and this cross-sectional configuration is assumed to be the same as the cross-sectional configuration of other actuators (for example, actuators 121b and 121c shown in FIG. 8).

The panel unit 110 includes, for example, a thin plate-shaped display cell 111 for displaying the video, an inner plate 112 arranged to oppose the display cell 111 through a gap 115 (opposing plate), and a back chassis 113. The inner plate 112 and the back chassis 113 may be integrated. The surface of the display cell 111 (surface opposite to vibration unit 120) has the video display surface 110A. The panel unit 110 further includes a fixing member 114 between the display cell 111 and the inner plate 112, for example.

The fixing member 114 has a function of fixing the display cell 111 and the inner plate 112 to each other and a function of serving as a spacer for maintaining the gap 115. The fixing member 114 is arranged along an outer edge of the display cell 111, for example. The fixing member 114 may, for example, have a flexibility that an edge of the display cell 111 behaves as a free edge when the display cell 111 is vibrated. The fixing member 114 is configured by, for example, a sponge having an adhesive layer on both surfaces thereof.

The inner plate 112 is a substrate for supporting the actuators 121 (121a, 121b, and 121c). The inner plate 112 has, for example, an opening (hereinafter referred to as “opening for actuator”) at a location for installing the actuators 121a, 121b, and 121c. The inner plate 112 further has one or more openings (hereinafter referred to as “air hole 114A”) apart from, for example, the opening for the actuator. The one or more air holes 114A function as air holes to mitigate a change in an air pressure that occur in the air gap 115 when the display cell 111 is vibrated while vibrating the actuators 121a, 121b, and 121c. The one or more air holes 114A are formed by avoiding the fixing member 114 so as not to overlap with the fixing member 114 and a vibration damping member 116, which will be described later.

The one or more air-holes 114A are, for example, cylindrical. The one or more air holes 114A may be rectangular cylindrical, for example. Each inner diameter of the one or more air holes 114A is, for example, about several centimeters. In addition, as long as one air hole 114A functions as the air hole, it may be configured by a large number of small-diameter through holes.

The back chassis 113 has a higher stiffness than the inner plate 112 and serves to suppress deflection or vibration of the inner plate 112. The back chassis 113 has an opening at a location opposed to, for example, an opening of the inner plate 112 (e.g., opening for actuator or air hole 114A). Of the openings provided in the back chassis 113, the opening provided at a location opposed to the opening for the actuator has a size capable of inserting the actuator 121a, 121b, or 121c. Of the openings provided in the back chassis 113, an opening provided at a location opposed to the air hole 114A functions as the air hole to mitigate the change of the air pressure generated in the air gap 115 when the display cell 111 is vibrated by the vibration of the actuators 121a, 121b, and 121c.

The back chassis 113 is formed of, for example, a glass substrate. Instead of the back chassis 113, a metal substrate or a resin substrate having the same rigidity as the back chassis 113 may be provided.

The vibration unit 120 includes, for example, three actuators 121a, 121b, and 121c. The actuators 121a, 121b, and 121c have a common configuration to each other.

The actuators 121a, 121b, and 121c in this example, for example, are arranged side by side in the left and right directions at a height location slightly above the center in the up and down directions of the display cell 111, which is an example.

Each of the actuators 121a, 121b, and 121c includes a voice coil, a voice coil bobbin, and a magnetic circuit, and is an actuator for a speaker serving as a vibration source.

Each of the actuators 121a, 121b, and 121c generates a driving force on the voice coil according to a principle of an electromagnetic action when a sound current of an electric signal flows through the voice coil. The driving force is transmitted to the display cell 111 via a vibration transmitting member 124, to thereby generate a vibration corresponding to a change in the sound current to the display cell 111, vibrate the air, and change a sound pressure.

A fixing member 123 and the vibration transmitting member 124 are provided for each of the actuators 121a, 121b, and 121c.

The fixing member 123, for example, has an opening for fixing the actuators 121a, 121b, and 121c while being inserted into the actuators 121a, 121b, and 121c. Each of the actuators 121a, 121b, and 121c is fixed to the inner plate 112 via, for example, the fixing member 123.

The vibration transmitting member 124 is, for example, in contact with a rear surface of the display cell 111, and the bobbin of each of the actuators 121a, 121b, and 121c, and is fixed to the rear surface of the display cell 111 and the bobbin of each of the actuators 121a, 121b, and 121c. The vibration transmitting member 24 is configured by a member at least having a repulsive characteristic in an acoustic wave region (20 Hz or more).

The panel unit 110, for example, as shown in FIG. 9, has the vibration damping member 116 between the display cell 111 and the inner plate 112. The damping member 116 has a function of preventing vibration generated in the display cell 111 by the actuators 121a, 121b, and 121c from interfering with each other.

The damping member 116 is arranged in a gap between the display cell 111 and the inner plate 112, that is, in the gap 115. The vibration damping member 116 is fixed to at least a back surface of the display cell 111 out of the back surface of the display cell 111 and a surface of the inner plate 112. The damping member 116 is in contact with the surface of the inner plate 112, for example.

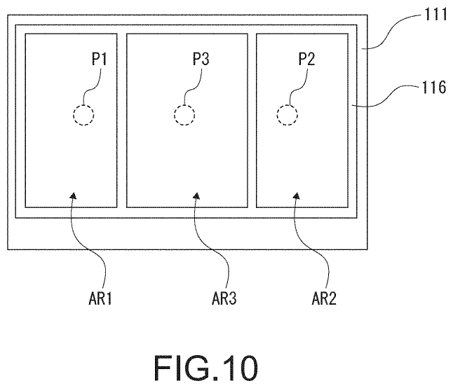

FIG. 10 shows a plane configuration example of the vibration damping member 116. Here, on the back surface of the display cell 111, locations opposed to the actuators 121a, 121b, and 121c are vibration points P1, P2, and P3.

In this instance, the vibration damping member 116 partitions the back surface of the display cell 111 into a vibration region AR1 including the vibration point P1, a vibration region AR2 including the vibration point P2, and a vibration region AR3 including the vibration point P3.

Each of the vibration regions AR1, AR2, and AR3 is a region that vibrates independently physically spaced apart.

That is, each of the vibration regions AR1, AR2, and AR3 is independently vibrated from each other by each of the actuators 121a, 121b, and 121c. In other words, each of the vibration regions AR1, AR2, and AR3 constitutes a speaker unit independent of each other.

Incidentally, three independent speaker units structure is formed in the panel unit 110 as an example of the description. Various examples in which a plurality of speaker units structures is formed in the panel unit 110 will be described later.

In addition, respective vibration regions AR1, AR2, and AR3 thus divided are not visually separated, as the display surface for the user to visually recognize the video, so that it is recognized as one display panel in an entire of the panel unit 110.

### 4. Comparative Example

In the television apparatus 2 having the above-described configuration, it describes that both the content sound and the agent sound are output by using the speaker 5.

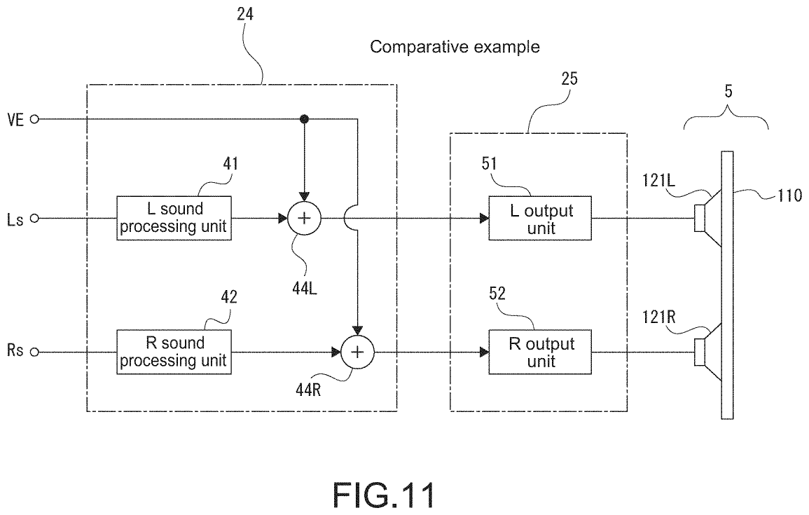

FIG. 11 shows a configuration example of a sound processing unit 24, a sound output unit 25, actuators 121 (121L and 121R), and the panel unit 110.

Incidentally, the “actuator 121” is a term that collectively refers to an actuator as a vibrator constituting the speaker unit.

A sound signal Ls of an L (left) channel and a sound signal Rs of an R (right) channel are input to the sound processing unit 24, for example, as content sounds of a two-channel stereo system.

An L sound processing unit 41 performs the various kinds of processing such as volume and sound quality processing (e.g., volume level adjustment, low-frequency enhancement processing, high-frequency enhancement processing, equalizing processing, etc.) and noise cancellation processing on the sound signal Ls.

An R sound processing unit 42 performs the various kinds of processing such as the volume and sound quality processing and the noise canceling processing on the sound signal Rs.

The sound signals Ls and Rs processed by the L sound processing unit 41 and the R sound processing unit 42 are supplied to an L output unit 51 and an R output unit 52 of the sound output unit 25 via mixers 44L and 44R, respectively. The L output unit 51 performs D/A conversion and amplification processing on the sound signal Ls, and supplies a speaker drive signal to an L channel actuator 121L. The R output unit performs the D/A conversion and the amplification processing on the sound signal Rs, and supplies the speaker drive signal to an R channel actuator 121R.

As a result, the panel unit 110 is vibrated by the actuators 121L and 121R, and the stereo sounds of the L and R channels about the video content are output.

In a case where the agent sound is output, a sound signal VE from the agent apparatus 1 is input to the mixers 44L and 44R of the sound processing unit 24.

As a result, the agent sound is mixed into the content sound, and is output from the panel unit 110 as the sound by the actuators 121L and 121R.

However, if such a configuration is adopted, it is assumed that the agent sound overlaps with the content sound, for example, a voice of an announcer reading news, a narration in a documentary, a serif of a movie, or the like, and both sounds are difficult to hear.

For this reason, it is necessary to reduce or mute the volume of the content sound when outputting the agent sound. In addition, if a sound image location of the agent sound and a sound image location of the content sound overlap, it remains difficult to hear even if the volume of the content sound is lowered.

In addition, lowering the content sound significantly will also disturb viewing and hearing the content.

Therefore, in this embodiment, as will be described below, in a case where the sound is reproduced by further vibrating the panel unit 110 by the actuator 121 in the television apparatus 2 in which the agent apparatus 1 is mounted, in addition to the actuator for reproducing the content sound, an actuator for reproducing the agent sound is arranged. The agent sound is then reproduced from a virtual sound source location by the localization processing.

This allows the sound content to be reproduced in a manner that matches the video, while allowing the agent sound to be heard in a different constant location, for example, from a location different from the television apparatus 2, so that the agent sound and the content sound can be separated and heard easily by the user.

### 5. First Embodiment

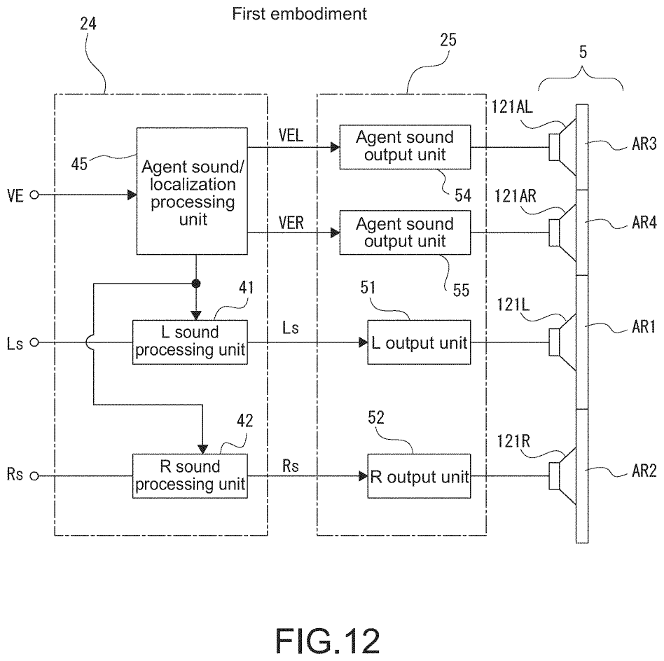

A configuration of the first embodiment is shown in FIG. 12. In configurations of respective embodiments to be described below, the sound processing unit 24, the sound output unit 25, the actuators 121 (121L and 121 121R) constituting the speaker 5, and the panel unit 110 in the configuration of the television apparatus 2 as described with reference to FIGS. 1 to 10 are extracted and illustrated. The parts described are denoted by the same reference numerals, and duplicate description thereof is avoided.

FIG. 12 shows a configuration in which the sound signals Ls and Rs are input as the content sound of, for example, the two-channel stereo system to the sound processing unit 24 in the same manner as in FIG. 11 above-mentioned above. In a case where the agent sound is output, the sound signal VE from the agent apparatus 1 is also input to the sound processing unit 24.

The L sound processing unit 41 performs the various kinds of processing such as the volume and sound quality processing and the noise canceling processing for the sound signal Ls, and supplies the sound signal Ls to the L output unit 51 in the sound output unit 25. The L output unit 51 performs the D/A conversion and the amplification processing on the sound signal Ls, and supplies the speaker drive signal to the L channel actuator 121L.

The actuator 121L is arranged so as to vibrate the vibration region AR1 of the panel unit 110, and outputs the sound corresponding to the sound signals Ls from the vibration region AR1. That is, the actuator 121L and the vibration region AR1 become an L channel speaker for the content sound.

The R sound processing unit 42 performs the various kinds of processing such as the volume and sound quality processing and the noise canceling processing for the sound signal Rs, and supplies the sound signal Rs to the R output unit 52 in the sound output unit 25. The R output unit 52 performs the D/A conversion and the amplification processing on the sound signal Rs, and supplies the speaker drive signal to the R channel actuator 121R.

The actuator 121R is arranged so as to vibrate the vibration region AR2 of the panel unit 110, and the sound is output corresponding to the sound signal Rs from the vibration region AR2. That is, the actuator 121R and the vibration region AR2 become an R channel speaker for the content sound.

The sound signal VE of the agent sound is necessary processing in the agent sound/localization processing unit 45 (hereinafter referred to as “sound/localization processing unit 45”) in the sound processing unit 24. For example, volume setting processing, sound quality setting processing, other channelization processing, and the like are performed. Furthermore, as the localization processing, processing (virtual sound source location reproduction signal processing) is performed so that the agent sound is heard from a virtual speaker location outside a panel front surface range for the user in front of the television apparatus 2.

Through such processing, the sound signals VEL and VER processed into two channels for the agent sound are output.

The sound signal VEL is supplied to the agent sound output unit 54 in the sound output unit 25. The agent sound output unit 54 performs the D/A conversion and the amplification processing for the sound signal VEL, and supplies the speaker drive signal to the actuator 121AL for an agent sound of the L channel.

The actuator 121AL is arranged so as to vibrate the vibration region AR3 of the panel unit 110, and the sound is output corresponding to the sound signal VEL from the vibration region AR3. That is, the actuator 121AL and the vibration region AR3 become the L channel speaker for the agent sound.

The sound signal VER is supplied to the agent sound output unit 55 in the sound output unit 25. The agent sound output unit 55 performs the D/A conversion and the amplification processing for the sound signal VER, and supplies the speaker drive signal to the actuator 121AR for the agent sound of the R channel.

The actuator 121AR is arranged so as to vibrate the vibration region AR4 of the panel unit 110, and the sound is output corresponding to the sound signal VER from the vibration region AR4. That is, the actuator 121AR and the vibration region AR4 become the R channel speaker for the agent sound.

As described above, the L and R channel sounds as the content sounds and the L and R channel sounds as the agent sounds are output from independent speaker units.

Hereinafter, the “speaker unit” will be described as referring to a set of the vibration region AR and the corresponding actuator 121.

Incidentally, the sound/localization processing unit 45 may control, for example, the L sound processing unit 41 and the R sound processing unit 42 so as to lower the volume of the content sound during a period of outputting the agent sound.

The localization processing by the sound/localization processing unit 45, i.e., the virtual sound source location reproduction signal processing is realized by performing binaural processing for multiplying head related transfer functions at a sound source location to be virtually arranged and crosstalk correction processing for canceling a crosstalk from the left and right speakers to ears when reproducing from the speakers. Although a detailed description is avoided because specific processing is known, it is disclosed, for example, in Patent Document 1.

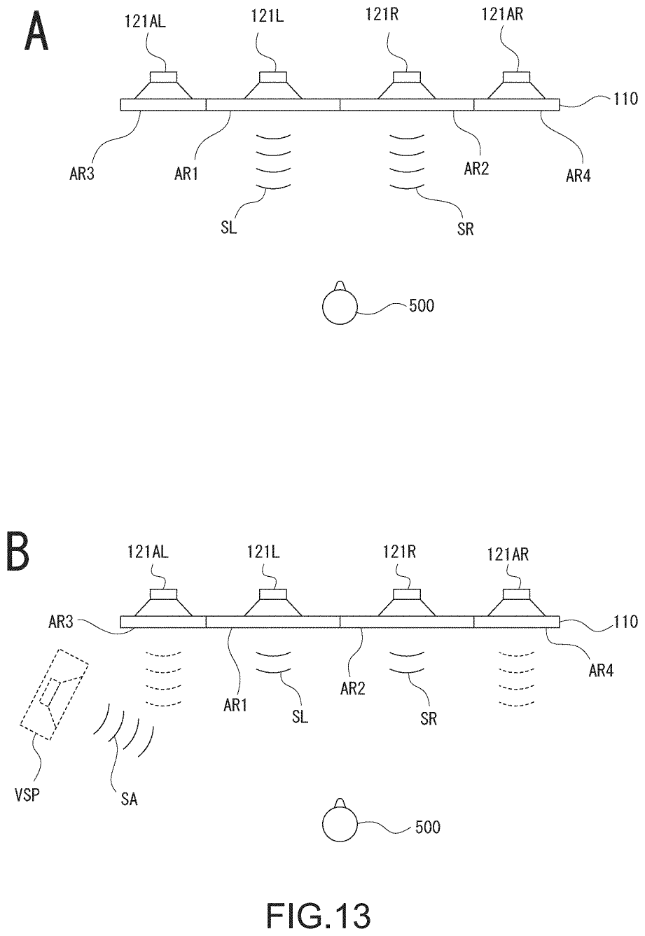

As a result, reproduction environments as shown in FIGS. 13A and 13B are realized.

FIG. 13A shows a situation in which a user 500 is located in front of the panel unit 110 and the content sound is reproduced.

The content sounds (SL, SR) are reproduced as L and R stereo sounds by the speaker unit formed by the set of the actuator 121L and the vibration region AR1 and the speaker unit formed by the set of the actuator 121R and the vibration region AR2.

FIG. 13B shows the case that the agent sound is reproduced.

The content sounds (SL, SR) are reproduced as the L and R stereo sounds by the speaker unit including the set of the actuator 121L and the vibration region AR1 and the speaker unit including the set of the actuator 121R and the vibration region AR2.

In addition, the agent sounds are reproduced as the L and R stereo sounds by the speaker unit by the set of the actuator 121AL and the vibration region AR3 and the speaker unit by the set of the actuator 121AR and the vibration region AR4. However, by the localization processing, the agent sound SA is heard by the user as if it originates from a location of a virtual speaker VSP outside the panel.

Thus, since the response sound from the agent apparatus 1 is heard from the virtual sound source location which is not on the display panel of the television apparatus 2, the agent sound can be clearly heard. Furthermore, the content sound can be reproduced without changing the sound volume as it is, or the volume may be lightly turned down. Therefore, content viewing and hearing is not disturbed.

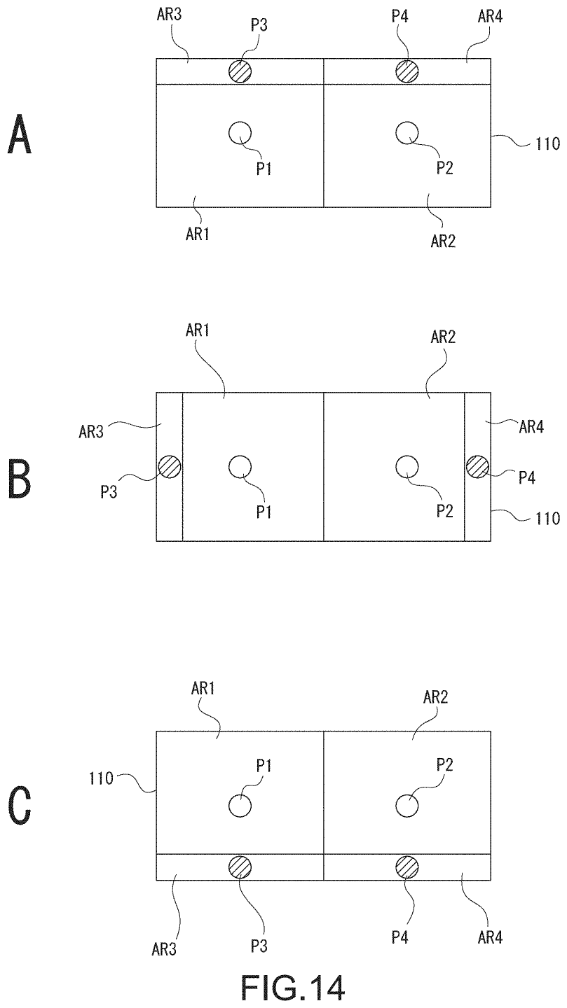

An arrangement example of the speaker unit by the actuator 121 and the vibration region AR is shown in FIG. 14.

Each figure shows a division setting of the vibration region AR1 when viewed from the front of the panel unit 110, and the arrangement location of the vibration point, that is, the actuator 121 behind.

The vibration points P1, P2, P3, and P4 are vibration points by the actuators 121L and 121R, 121AL, 121AR, respectively.

In each figure, diagonal lines are added to the vibration points (vibration points P3 and P4 in the case of first embodiment) by the actuator 121 for the agent sound to distinguish them from the vibration points for the content sound (vibration points P1 and P2 in the case of first embodiment).

In FIG. 14A, a panel surface is divided into left and right at the center, and the vibration regions AR1 and AR2 are provided as relatively wide regions. Then, the vibration regions AR3 and AR4 are provided as relatively narrow regions in the above. In the respective vibration regions AR1, AR2, AR3, AR4, vibration points P1, P2, P3, and P4 are set at an approximate center thereof. That is, the arrangement locations of the actuators 121L and 121R, 121AL, 121AR are set at the approximate centers of back surface sides of respective vibration regions AR1, AR2, AR3, and AR4.

With such a speaker unit setting, it is possible to appropriately output the content sounds of the left and right two channels, and it is also possible to realize various sound constant locations of the agent sound by the left and right speaker units.

The agent sound is also the response sound or the like and does not require much reproduction capability. For example, it is sufficient to be able to output a low band from about 300 Hz to about 400 Hz. Therefore, it can function sufficiently even in the narrow vibration regions. It is also resistant to image shaking because it requires less displacement of vibration.

Then, by narrowing the vibration regions AR3 and AR4 for the agent sound, a wide area of the panel unit 110 can be used for the content sound, and a powerful sound reproduction can be realized. For example, it is possible to form a speaker unit for the content sound reproducing the low frequency range from 100 Hz to 200 Hz.

FIG. 14B shows the panel surface divided into four panels in the horizontal direction. The wide regions at the center are defined as the vibration regions AR1 and AR2, and the vibration regions AR3 and AR4 are defined as the relatively narrow regions at the left and right edges.

FIG. 14C shows an example in which the vibration regions AR1 and AR2 are provided as relatively wide regions and the vibration regions AR3 and AR4 are provided as relatively narrow regions in the below after the panel surface is divided into left and right at the center.

In any of the examples, respective vibration points P1, P2, P3, and P4 are set in the approximate centers of the vibration regions AR1, AR2, AR3, and AR4.

Various vibration region AR settings are considered as described above. Needless to say, examples other than the illustrated examples are also assumed.

Each of the vibration points P1, P2, P3, and P4 is at the approximate center of each vibration region AR, but it is an example, it may be a location displaced from the center, or a corner of the vibration region AR.

### 6. Second Embodiment

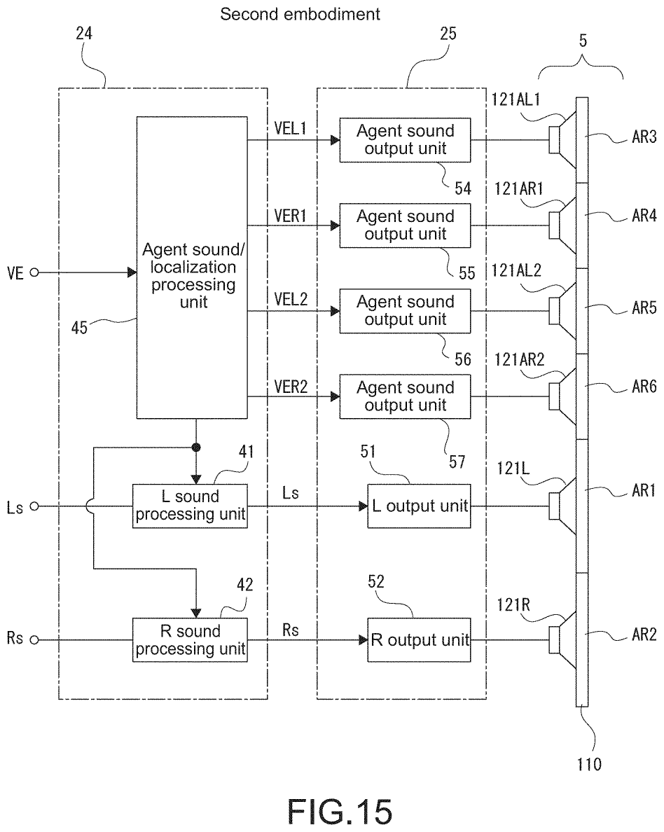

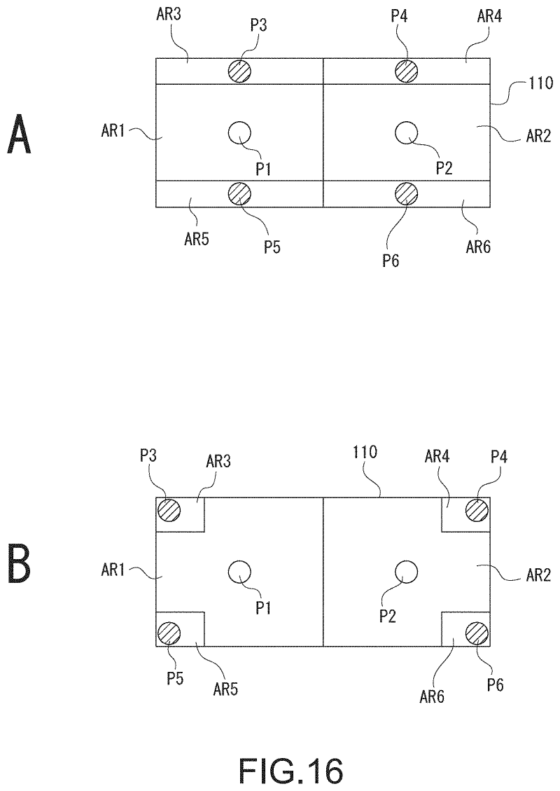

A second embodiment will be explained with reference to FIGS. 15 and 16.

This is an example in which four speaker units are formed for the agent sound.

As shown in FIG. 15, the sound/localization processing unit 45 generates four-channel sound signals VEL1, VER1, VEL2, VER2 as the agent sounds.

These sound signals VEL1, VER1, VEL2, and VER2 are output-processed by the agent sound output units 54, 55, 56, and 57, respectively, and the speaker drive signals corresponding to the sound signals VEL1, VER1, VEL2, and VER2 are supplied to the actuators 121AL1, 121AR1, 121AL2, and 121AR2, respectively. The actuators 121AL1, 121AR1, 121AL2, and 121AR2 vibrate in one-to-one correspondence to the vibration regions AR3, AR4, AR5, and AR6, respectively.

A speaker unit arrangement is as shown in FIG. 16, for example.

In the example of FIG. 16A, the panel surface is divided into left and right at the center, and the vibration regions AR1 and AR2 are provided as relatively wide regions. Then, the vibration regions AR3, AR4, AR5, and AR6 are provided as relatively narrow region above and below. The vibration regions AR3, AR4, AR5, and AR6 of the vibration regions are the vibration points by the actuators 121AL1, 121AR1, 121AL2, and 121AR2, respectively, and in this case, the vibration points P3, P4, P5, and P6 are provided at the approximate center of the corresponding vibration regions AR.

In the example of FIG. 16B, the vibration regions AR1 and AR2 are provided by dividing the panel surface into left and right at the center. Then, the vibration region AR3 is provided at an upper left corner of the vibration region AR1, and the vibration region AR5 is provided at a lower left corner. In addition, the vibration region AR4 is provided at an upper right corner of the vibration region AR2, and the vibration region AR6 is provided at a lower right corner.

The vibration points P3, P4, P5, and P6 by the actuators 121AL1, 121AR1, 121AL2, and 121AR2 are assumed to be the locations biased to each corner of the panel.

As described above, by arranging the speaker units for the agent sound so as to be spaced apart from each other in the up, down, left, and right directions, the constant location of the agent sound can be easily set more variously. For example, in a space extending from a plane of the panel unit 110 to a periphery, an arbitrary virtual speaker location in the up and down directions and the left and right directions can be set by adding relatively simple localization processing to the sound signal.

### 7. Third Embodiment

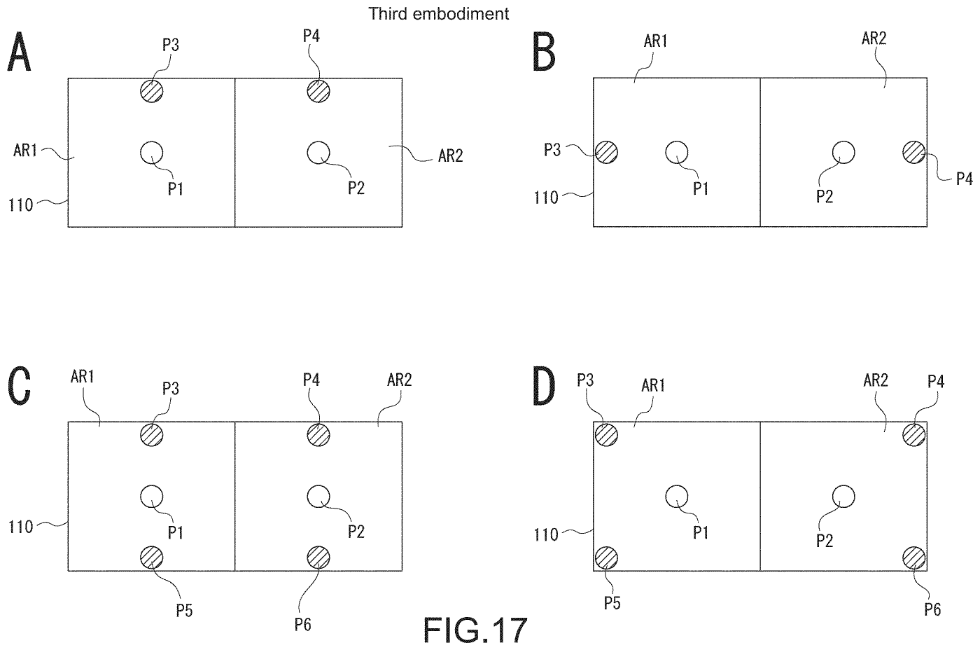

A third embodiment will be described with reference to FIG. 17.

This is an exemplary arrangement of a plurality of actuators 121 in one vibration region AR1.

In FIG. 17A, a screen of the panel unit 110 into two vibration regions AR1 and AR2 on the left and right.

In the vibration region AR1, the vibration point P1 for the content sound is arranged at the approximate center, and the vibration point P3 for the agent sound is arranged above.

Furthermore, in the vibration region AR2, the vibration point P2 for the content sound is arranged at the approximate center, and the vibration point P4 for the agent sound is arranged above.

FIG. 17B also divides the screen of the panel unit 110 into the two vibration regions AR1 and AR2 on the left and right.

In addition, in the vibration region AR1, the vibration point P1 for the content sound is arranged at the approximate center, and the vibration point P3 for the agent sound is arranged at a left corner thereof.

Furthermore, in the vibration region AR2, the vibration point P2 for the content sound is arranged at the approximate center, and the vibration point P4 for the agent sound is arranged at a right corner thereof.

The above-described examples of FIG. 17A and FIG. 17B correspond to a configuration in which the vibration regions AR1 and AR3 in FIG. 12 (FIG. 14A, FIG. 14B) are collectively as one vibration region AR1, and the vibration regions AR2 and AR4 are collectively as one vibration region AR2.

In these cases, since the agent sounds are also output by the left and right speaker units, setting of the virtual speaker location at the location outside the panel in the left and right directions is facilitated.

In FIG. 17C, the screen of the panel unit 110 is divided into the two vibration regions AR1 and AR2 on the left and right, the vibration point P1 for the content sound is arranged in the vibration region AR1 at the approximate center, and the vibration points P3 and P5 for the agent sound are arranged above and below.

Furthermore, in the vibration region AR2, the vibration point P2 for the content sound is arranged at the approximate center, and the vibration points P4 and P6 for the agent sound are arranged above and below.

In FIG. 17D, the screen of the panel unit 110 is divided into the two vibration regions AR1 and AR2 on the left and right sides, the vibration point P1 for the content sound is arranged in the approximate center of the vibration region AR1, and the vibration points P3 and P5 for the agent sound are arranged in an upper left corner and a lower left corner.

Furthermore, in the vibration region AR2, the vibration point P2 for the content sound is arranged at the approximate center, and the vibration points P4 and P6 for the agent sound are arranged at an upper right corner and a lower right corner.

The above-described examples of FIG. 17C and FIG. 17D correspond to a configuration in which the vibration regions AR1, AR3, and AR5 in FIG. 15 (FIG. 16A, FIG. 16B) are collectively as one vibration region AR1, and the vibration regions AR2, AR4, and AR6 are collectively as one vibration region AR2.

In these cases, since the agent sound is also output by the left and right upper and lower speaker units, the setting of the virtual speaker location at the location outside the panel in the left and right directions and the up and down directions is facilitated.

### 8. Fourth Embodiment

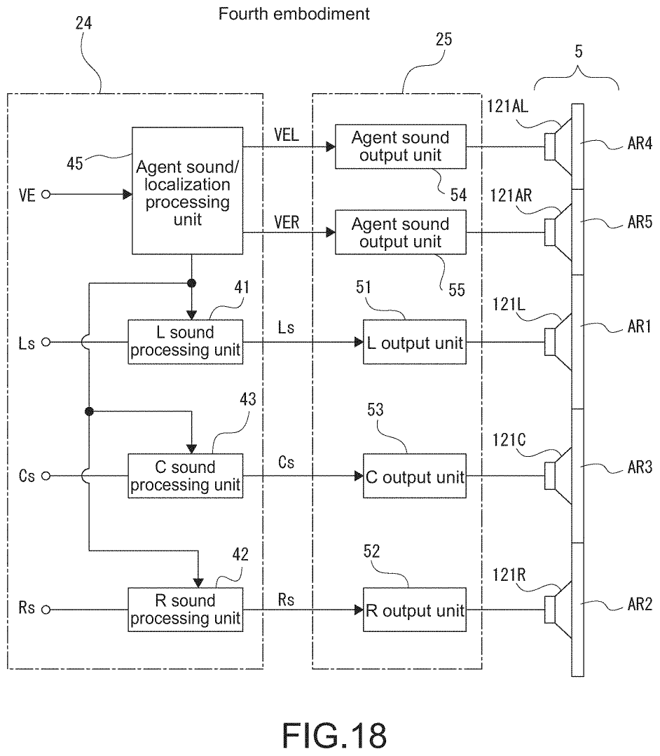

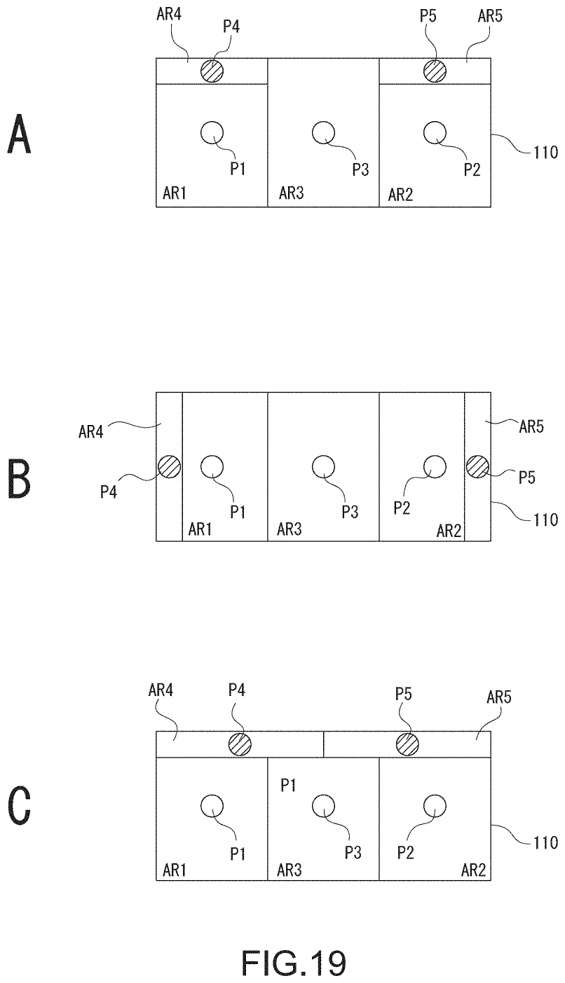

A fourth embodiment will be described with reference to FIGS. 18 and 19.

This is an example of outputting the content sound in three channels L, R, and center (C).

FIG. 18 shows a configuration in which, for example, three-channel sound signals Ls, Rs, Cs of the three channels of L, R, and the center are input or generated as the content sounds in the sound processing unit 24.

In addition to the configuration corresponding to the L and R channels described in FIG. 12, a center sound processing unit 43 is provided. The center sound processing unit 43 performs various kinds of processing such as the volume and sound quality processing and the noise canceling processing for the sound signal Cs, and supplies the sound signal Cs to a center output unit 53 in the sound output unit 25. The center output unit 53 to the sound signal Cs, performs the D/A conversion and the amplifying processing, and supplies the speaker drive signal to the actuator 121C for a center channel.

The actuator 121C is arranged so as to vibrate the vibration region AR3 of the panel part 110, and the sound output corresponding to the sound signal Cs is performed from the vibration region AR3. In other words, the actuator 121C and the vibration region AR3 become a center channel speaker for the content sound.

Incidentally, in the embodiment of FIG. 18, the actuator 121AL and the vibration region AR4 are the speaker unit for a left channel of the agent sound, and the actuator 121AR and the vibration region AR5 are the speaker unit for a right channel of the agent sound.

The speaker unit arrangement is as shown in FIG. 19.

In FIG. 19A, FIG. 19B, and FIG. 19C, the vibration points P1, P2, P3, P4, and P5 are vibration points by the actuators 121L and 121R, 121C, 121AL, and 121AR in FIG. 18, respectively.

In FIG. 19A, the panel surface is divided into three regions in the left and right directions, and the vibration regions AR1, AR2, and AR3 are provided as relatively wide regions. The vibration region AR4 is provided as a relatively narrow region above the vibration region AR1, and the vibration region AR5 is provided as a relatively narrow region above the vibration region AR2.

In the example of FIG. 19B, the panel surface is also divided into three regions in the left and right directions, and provides the vibration regions AR1, AR2, and AR3 as the relatively wide regions. The vibration region AR4 is provided as the relatively narrow region on the left side of the vibration region AR1, and the vibration region AR5 is provided as the relatively narrow region on the right side of the vibration region AR2.

In the example of FIG. 19C, the panel surface is also divided into three regions in the left and right directions, and provides the vibration regions AR1, AR2, AR3 as the relatively wide regions. The region serving as an upper end side of the panel unit 110 is divided into to the left and right, the vibration region AR4 is provided as the relatively narrow region on the left side, and the vibration region AR5 is provided as the relatively narrow region on the right side.

As an example as described above, in a case where the content sound is output by each channel of the L, R, and center, the agent sound can be reproduced at a predetermined constant location by an independent speaker unit.

Note that, in the above-described FIG. 19A, FIG. 19B, and FIG. 19C, the vibration points P1, P2, P3, P4, and P5 are provided at the approximate center of the corresponding vibration regions AR, but it is not limited thereto.

### 9. Fifth Embodiment

As a fifth embodiment, a case will be described in which the content sound is output on the L, R, and center channels and the agent sound is output on 4 channels. The configuration of the sound processing unit 24 and the sound output unit 25 is a combination of a content sound system of FIG. 18 and an agent sound system of FIG. 15.

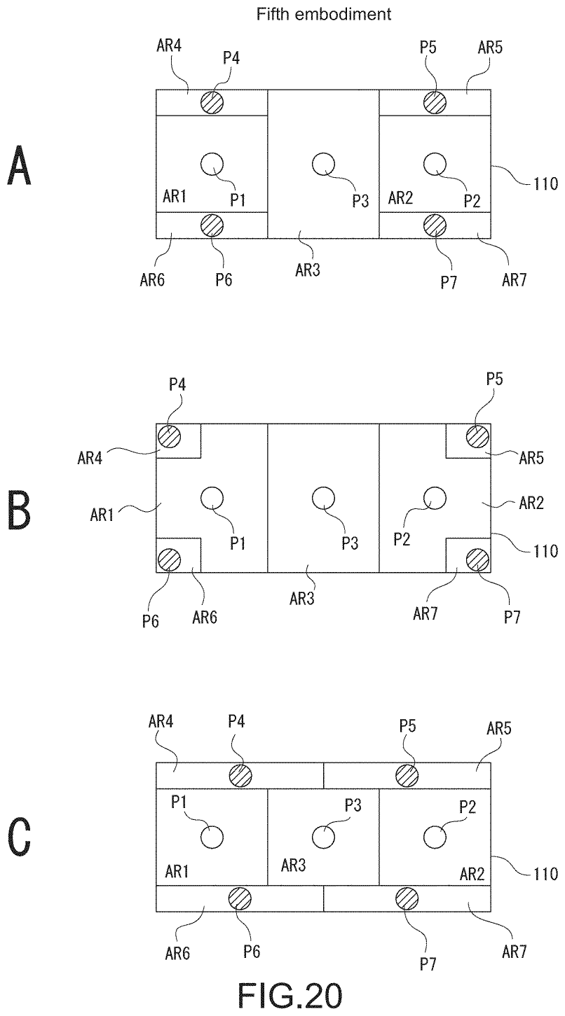

A speaker unit arrangement is as shown in FIG. 20.

In FIG. 20A, FIG. 20B, and FIG. 20C, the vibration points P1, P2, and P3 are the vibration points by the actuators 121L, 121R, 121C for the content sound as shown in FIG. 18, and the vibration points P4, P5, P6, and P7 are the vibration points by the actuators 121AL1, 121AR1, 121AL2, and 121AR2 for the agent sound as shown in FIG. 15, respectively.

In the example of FIG. 20A, the panel surface is divided into three regions in the left and right directions, and the vibration regions AR1, AR2, and AR3 for the content sound are provided as the relatively wide regions.

The vibration regions AR4 and AR6 for a vibration agent sound are provided as the relatively narrow regions above and below the vibration region AR1, and the vibration regions AR5 and AR7 for the agent sound are provided as the relatively narrow regions above and below the vibration region AR2.

In the example of FIG. 20B, the panel surface is also divided into three regions in the left and right directions, and provides the vibration regions AR1 and AR2, and AR3 for the content sound as the relatively wide regions.

The vibration regions AR4 and AR6 for the agent sound are provided as the relatively narrow regions in an upper left corner and an upper right corner of the vibration region AR1, and the vibration regions AR5 and AR7 for the agent sound are provided as the relatively narrow regions in the upper right corner and the lower right corner of the vibration region AR2.

In the example of FIG. 20C, the panel surface is also divided into three regions in the left and right directions, and provides the vibration regions AR1, AR2, and AR3 for the content sound as the relatively wide regions.

The region serving as an upper end side of the panel unit 110 is divided into right and left, and the vibration regions AR4 and AR5 for the agent sound are provided as the relatively narrow regions on the left and right.

The region serving as the lower end of the panel unit 110 is also divided into right and left, and the vibration regions AR6 and AR7 for the agent sound as the relatively narrow regions on the left and right.

As an example as described above, in a case where the content sound is output by each channel of the L, R, and center, the agent sound can be reproduced at the predetermined constant location by independent speaker units of four channels.

### 10. Sixth Embodiment

A sixth embodiment is an example in which a vibration surface is shared in the fourth and fifth embodiments.

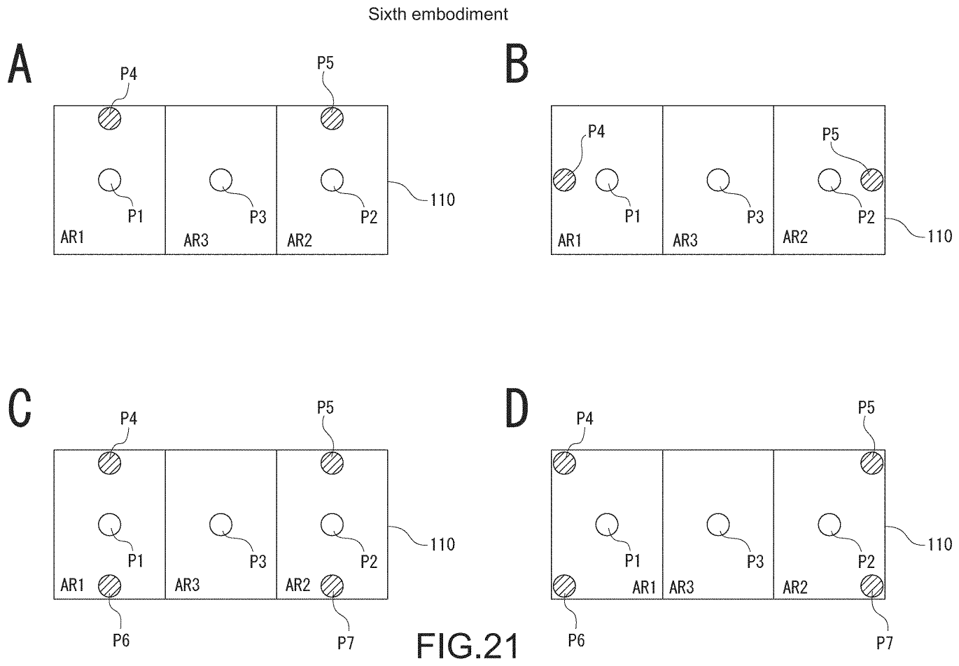

FIG. 21A shows an example in which the vibration points P1 and P4 in FIG. 19A are provided in one vibration region AR1, and the vibration points P2 and P5 are provided in one vibration region AR2.

FIG. 21B shows an example in which the vibration points P1 and P4 in FIG. 19B are provided in one vibration region AR1, and the vibration points P2 and P5 are provided in one vibration region AR2.

FIG. 21C shows examples in which the vibration points P1, P4, and P6 in FIG. 20A are provided in one vibration region AR1, and the vibration points P2, P5, and P7 are provided in one vibration region AR2.

FIG. 21D shows examples in which the vibration points P1, P4, and P6 in FIG. 20B are provided in one vibration region AR1, and the vibration points P2, P5, and P7 are provided in one vibration region AR2.

In order to hear the difference between the content sound and the agent sound, it is preferable to use one actuator 121 in one vibration region AR as in the fourth and fifth embodiments, but even if the vibration region AR is shared as in the sixth embodiment, the actuator 121 for the agent sound and the actuator 121 for the content sound are independent, thereby hearing the difference to a certain degree.

In particular, if an area of the vibration region AR is large, separate sounding occurs in each part in the regions (for each periphery of vibration points), so that the difference between the sounds can be heard.

### 11. Seventh Embodiment

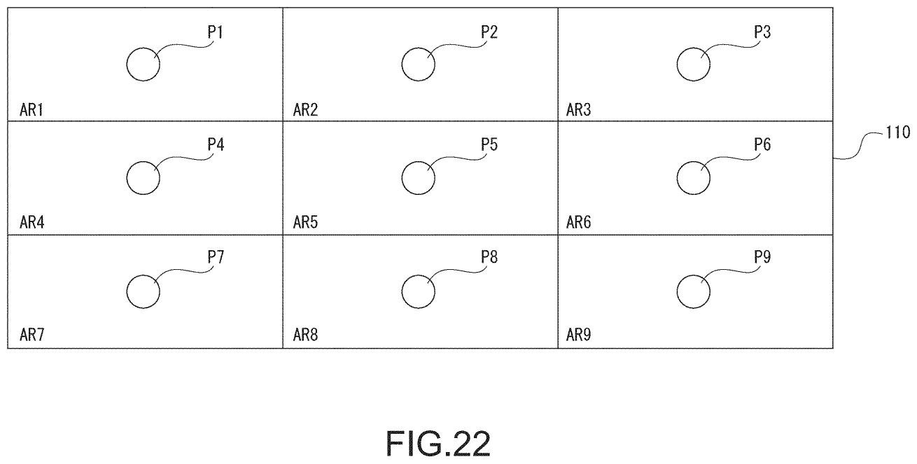

In seventh, eighth, ninth, and tenth embodiments below, an example in which the vibration region AR is divided into nine as shown in FIG. 22 will be described. The vibration regions AR1, AR2, AR3, AR4, AR5, AR6, AR7, AR8, and AR9 from upper left to lower right of the panel unit 110. It assumes that each vibration region AR has the same area.

A whole or a part of the vibration region AR is switched to be used for the content sound and the agent sound.

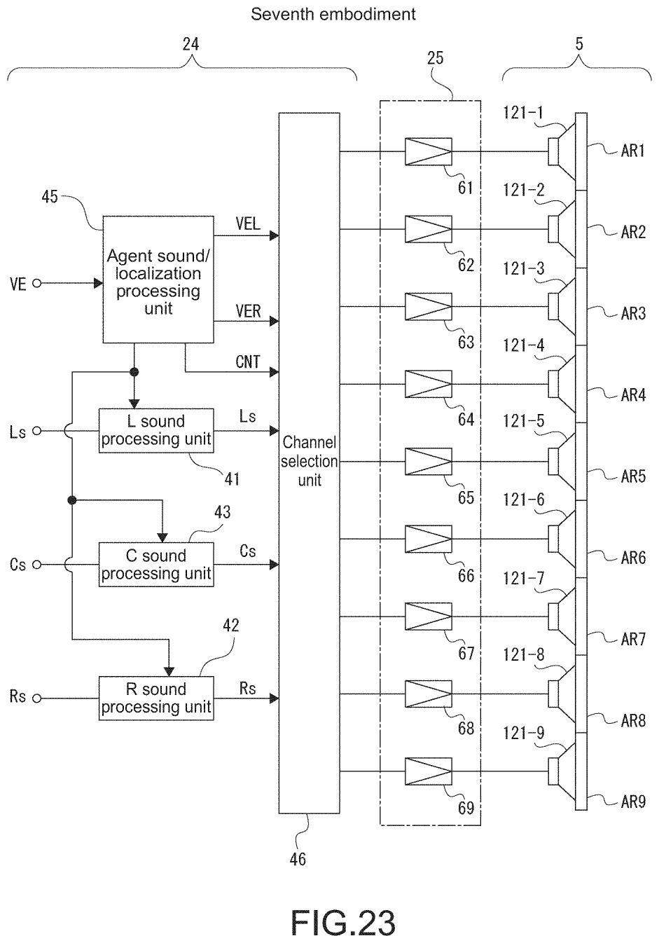

A configuration of the seventh embodiment is shown in FIG. 23.

In the sound processing unit 24, the sound signals Ls, Rs, and Cs of the three channels L, R, the center are processed and supplied to the channel selection unit 46.

In the sound processing unit 24, the sound signals Ls, Rs, and Cs of the three channels L, R, the center are processed, and the sound/localization processing unit 45 generates the sound signals VEL and VER of the two channels of the agent sound signals and supplies them to the channel selection unit 46.

The channel selection unit 46 performs processing for sorting the sound signals Ls, Rs, Cs, VEL, and VER of the above total five channels to nine vibration regions AR depending on the control signal CNT from the sound/localization processing unit 45.

The sound output unit 25 includes nine output units 61, 62, 63, 64, 65, 66, 67, 68, and 69 corresponding to the nine vibration regions AR, performs the D/A conversion and the amplification processing for the input sound signal, and outputs each speaker drive signal based on the sound signal. Then, each speaker drive signal by the nine output units 61, 62, 63, 64, 65, 66, 67, 68, and 69 is supplied to the actuators 121-1, 121-2, 121-3, 121-4, 121-5, 121-6, 121-7, 121-8, and 121-9 corresponding at 1:1 for each of the nine vibration regions AR.

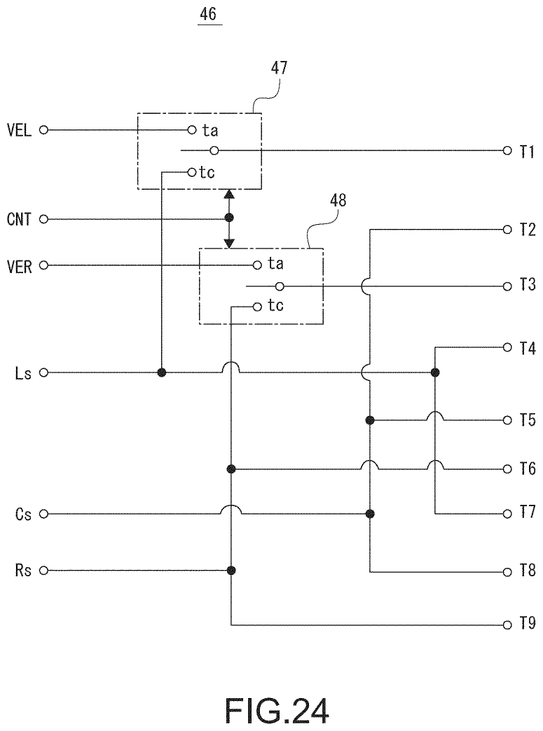

In this case, a configuration as shown in FIG. 24 is conceivable as the channel selection unit 46.

The terminals T1, T2, T3, T4, T5, T6, T7, T8, and T9 are terminals for supplying the sound signals to the output units 61, 62, 63, 64, 65, 66, 67, 68, and 69, respectively.

The sound signal VEL is supplied to a terminal ta of a switch 47.

The sound signal VER is supplied to a terminal ta of a switch 48.

The sound signal Ls is supplied to a terminal tc of the switch 47, a terminal T4, and a terminal T7.

The sound signal Cs is supplied to the terminal tc, the terminal T4, and the terminal T8.

The sound signal Rs is supplied to the terminal tc of the switch 48, a terminal T6, and a terminal T9.

The switch 47 is connected to the terminal T1, the switch 48 is connected to the terminal T3.

In the switches 47 and 48, the terminal to is selected during a period in which the agent sound is output (period in which agent sound is output in addition to content sound) by the control signal CNT, and the terminal tc is selected during a period other than the period in which the agent sound is not output and only the content sound is output.

In such a configuration, the speaker unit by the vibration region AR1 and the actuator 121-1 and the speaker unit by the vibration region AR3 and the actuator 121-3 are used by switching for the content sound and the agent sound.

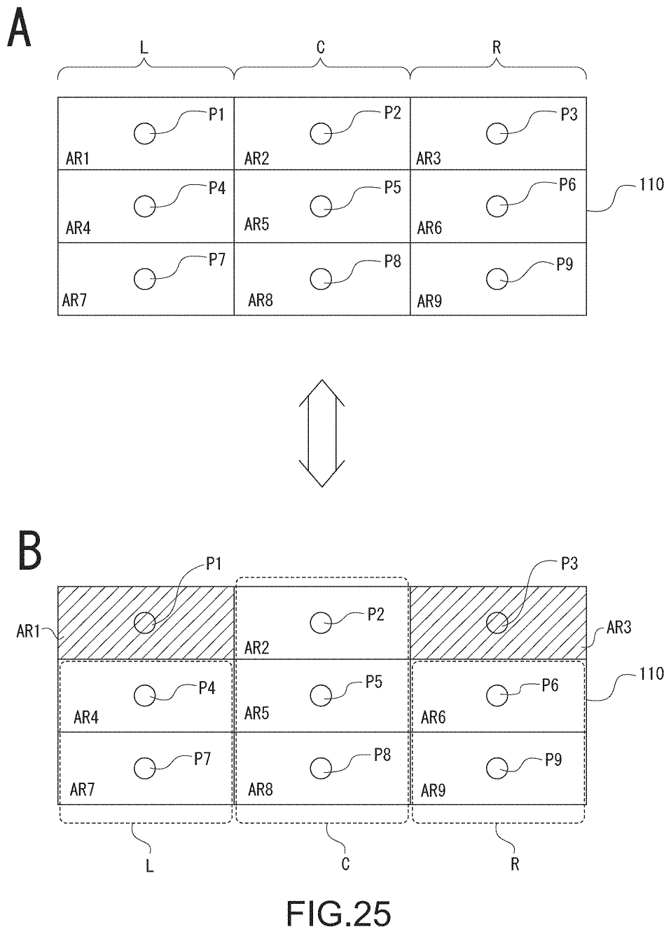

That is, during the period of outputting only the content sound, as shown in FIG. 25A, the vibration regions AR1, AR4, and AR7 are used as the L channel speaker.

In addition, the vibration regions AR3, AR6, and AR9 are used as the speakers of the R channel, and the vibration regions AR2, AR5, and AR8 are used as the center channel (C channel) speaker.

The vibration points P1 to P9 are the vibration points by the actuators 121-1 to 121-9, respectively.

On the other hand, when the agent sound is output, as shown in FIG. 25B, the vibration regions AR4 and AR7 are used as the L channel speaker, the vibration regions AR6 and AR9 are used as the R channel speaker, and the vibration regions AR2, AR5, and AR8 are used as the center channel (C channel) speaker. The vibration regions AR1 and AR3 to which the diagonal lines are added will be used as the left-channel and right-channel speakers of the agent sound, respectively.

By switching and using some of the speaker units in this manner, when the agent sound is not output, a high-performance and high-output content sound speaker can be realized by using all of the speaker units.

In addition, by switching some speaker units to the agent sound, the agent sound can be output at the predetermined constant location while naturally suppressing a content sound output.

Furthermore, in this case, as the center speaker, the vibration regions AR2, AR5, and AR8 are always used. This is suitable for outputting the content sound, where the center channel often outputs an important sound.

It should be noted that the examples of FIGS. 24 and 25 are illustrative, and which speaker unit is used for the agent sound may be variously considered.

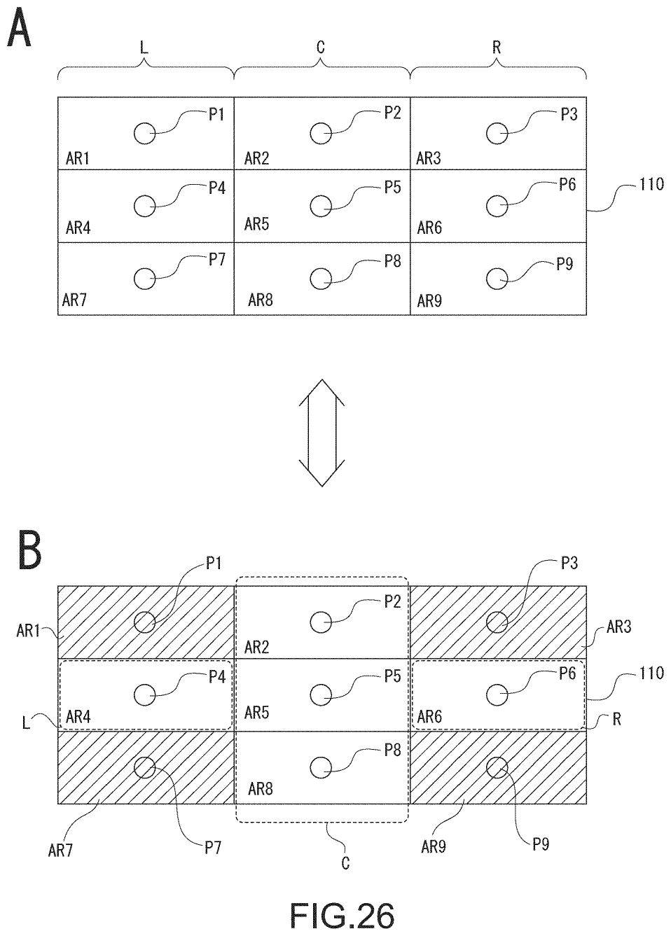

For example, FIG. 26A and FIG. 26B show examples in which four speaker units are used for the agent sound.

During the period when only the content sound is output, all the vibration regions ARs are used for the content sound as shown in FIG. 26A (similar to FIG. 24A).

The period of outputting the agent sound, as shown in FIG. 26B, the vibration region AR4 is used as the L channel speaker, the vibration region AR6 is used as the R channel speaker, and the vibration regions AR2, AR5, and AR8 are used as the center channel (C channel) speaker.

The vibration regions AR1 and AR7 to which the diagonal lines are added are used as the left channel speaker of the agent sound, and the vibration regions AR3 and AR9 are used as the right channel speaker of the agent sound.

Needless to say, various other examples are conceivable. The center vibration regions AR2, AR5, and AR8 may be used to switch to the agent sound.

### 12. Eighth Embodiment

An eighth embodiment is an example of outputting, for example, the content sound in nine channels.

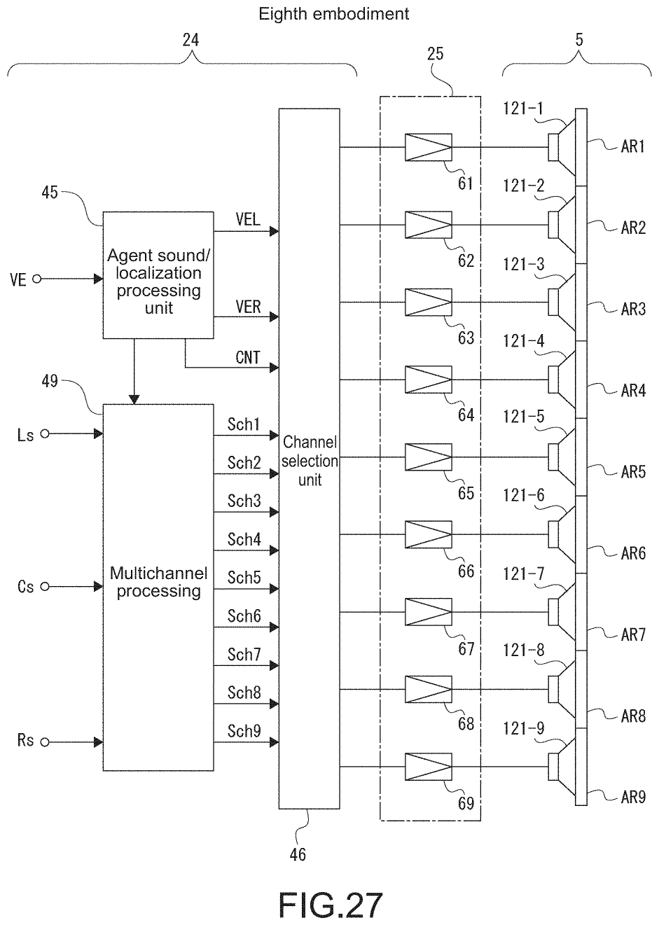

As shown in FIG. 27, the sound signals Ls, Rs, and Cs as the content sound are processed into nine channels in a multichannel processing unit 49. Then, they are output as nine channel sound signals Sch1, Sch2, Sch3, Sch4, Sch5, Sch6, Sch7, Sch8, and Sch9.

These sound signals Sch1, Sch2, Sch3, Sch4, Sch5, Sch6, Sch7, Sch8, and Sch9 are the sound signals for vibrating the vibration regions AR1, AR2, AR3, AR4, AR5, AR6, AR7, AR8, and AR9, respectively.

In the channel selecting section 46, the sound signals (from Sch1 to Sch9) of the nine channels as the content sounds and the sound signals VEL and VER of the two L and R channels as the agent sound signals from the sound/localization processing section 45 are input, and the sound signals are sorted to nine vibration regions AR corresponding to the control signals CNT from the sound/localization processing section 45.

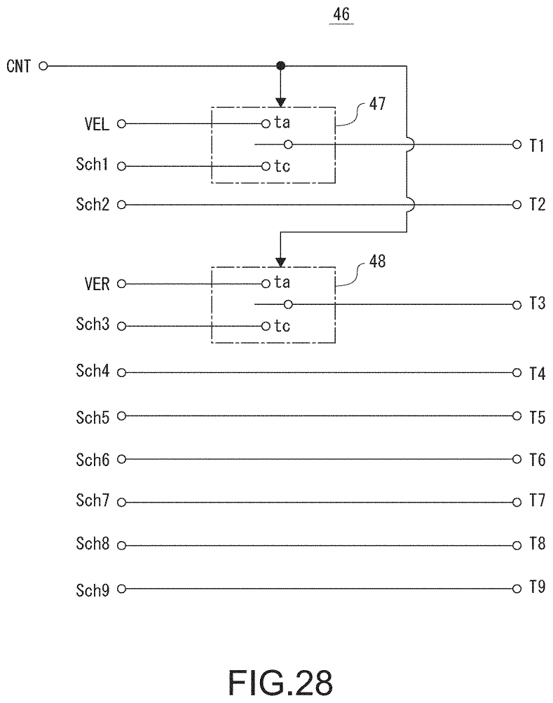

For example, the channel selection unit 46 is configured as shown in FIG. 28.

The sound signal VEL is supplied to the terminal ta of the switch 47.

The sound signal VER is supplied to the terminal ta of the switch 48.

The sound signal Sch1 is supplied to the terminal tc of the switch 47.

The sound signal Sch3 is supplied to a terminal tc of the switch 48.

The output of the switch 47 is supplied to the terminal T1, and the output of the switch 48 is supplied to the terminal T3.

The sound signals Sch2, Sch4, Sch5, Sch6, Sch7, Sch8, and Sch9 are supplied to the terminals T2, T4, T5, T6, T7, T8, and T9, respectively.

With such a configuration, the vibration regions AR1 and AR3 are switched and used between the time of outputting the content sound and the time of outputting the content sound and the agent sound, as shown in FIG. 25A and FIG. 25B as described above.

### 13. Ninth Embodiment

A ninth embodiment is an example in which the speaker unit (a set of vibration region AR and actuator 121) to be switched and used for the content sound and the agent sound as described above is selected depending on a situation at that time.

The configuration of the sound processing unit 24 is as shown in the example of FIG. 27.

However, the channel selection unit 46 is configured to be able to execute the sound output based on the sound signal VEL as the agent sound in any of the vibration regions AR1, AR4, and AR7 on the left side of the screen, and to execute the sound output based on the sound signal VER as the agent sound in any of the vibration regions AR3, AR6, and AR9 on the right side of the screen.

That is, the channel selection unit 46 has a configuration that allows selection of the sound signal Sch1 and the sound signal VEL as the signals to be supplied to the output unit 61, allows selection of the sound signal Sch4 and the sound signal VEL as the signals to be supplied to the output unit 64, and allows selection of the sound signal Sch7 and the sound signal VEL as the signals to be supplied to the output unit 67.

In addition, the channel selection unit has a configuration that allows selection of the sound signal Sch3 and the sound signal VER as the signals to be supplied to the output unit 63, allows selection of the sound signal Sch6 and the sound signal VER as the signals to be supplied to the output unit 66, and allows selection of the sound signal Sch9 and the sound signal VER as the signals to be supplied to the output unit 69.

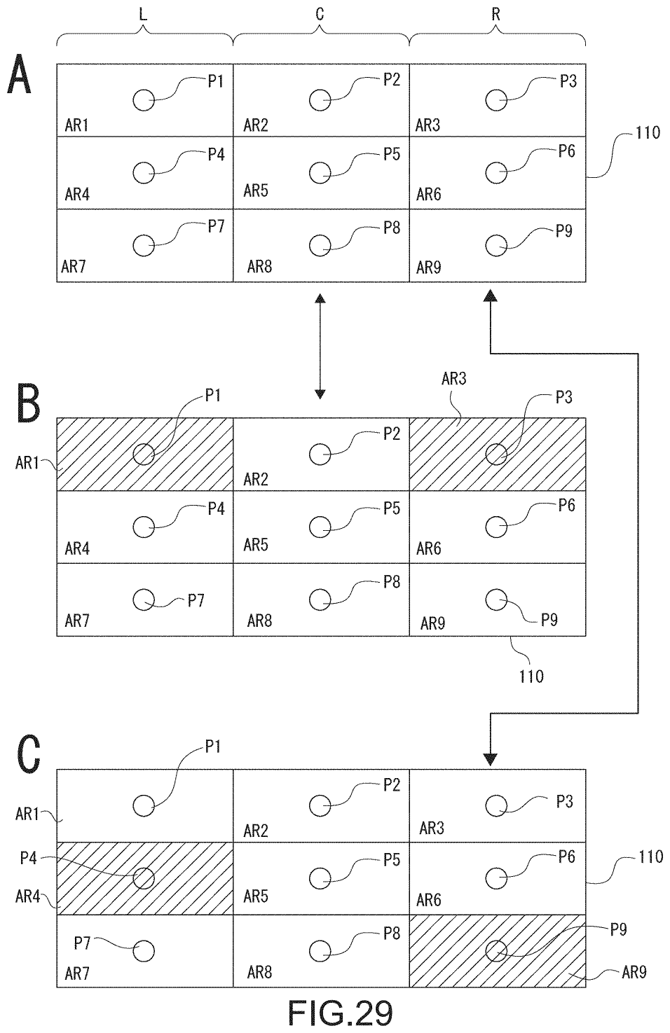

With such a configuration, for example, speaker unit selection as shown in FIG. 29 is performed.

That is, during a period in which only the content sound is output, as shown in FIG. 29A, the speaker output of the nine channels is executed by the sound signal Sch1 to Sch9 from the vibration regions AR1 to AR9.

Incidentally, the vibration points P1 to P9 are the vibration points by the actuators 121-1 to 121-9 in FIG. 27, respectively.

On the other hand, when the agent sound is output, for example, as shown in FIG. 29B, the vibration region AR1 selected among the vibration regions AR1, AR4, and AR7 is used as the L channel speaker, and the vibration region AR3 selected among the vibration regions AR3, AR6, and AR9 is used as the R channel speaker.

Other vibration regions AR2, AR4, AR5, AR6, AR7, AR8, and AR9 to which the diagonal lines are not added are used as the speakers corresponding to the sound signals Sch2, Sch4, Sch5, Sch6, Sch7, Sch8, Sch9, respectively.

At other times when the agent sound is output, for example, as in FIG. 29C, the vibration region AR4 selected among the vibration regions AR1, AR4, and AR7 is used as the L channel speaker, and the vibration region AR9 selected among the vibration regions AR3, AR6, and AR9 is used as the R channel speaker.

Other vibration regions AR1, AR2, AR3, AR5, AR6, AR7, and AR8 to which the diagonal lines are not added are used as the speakers corresponding to the sound signals Sch1, Sch2, Sch3, Sch5, Sch6, Sch7, and Sch8, respectively.

Such selection is performed, for example, depending on an output volume of each channel.

For example, when outputting the agent sound, the vibration region AR with the lowest volume level among the vibration regions AR1, AR4, and AR7 is selected for the left channel of the agent sound. Also, the vibration region AR with lower volume level among the vibration regions AR3, AR6, and AR9, is selected for the right channel of the agent sound.

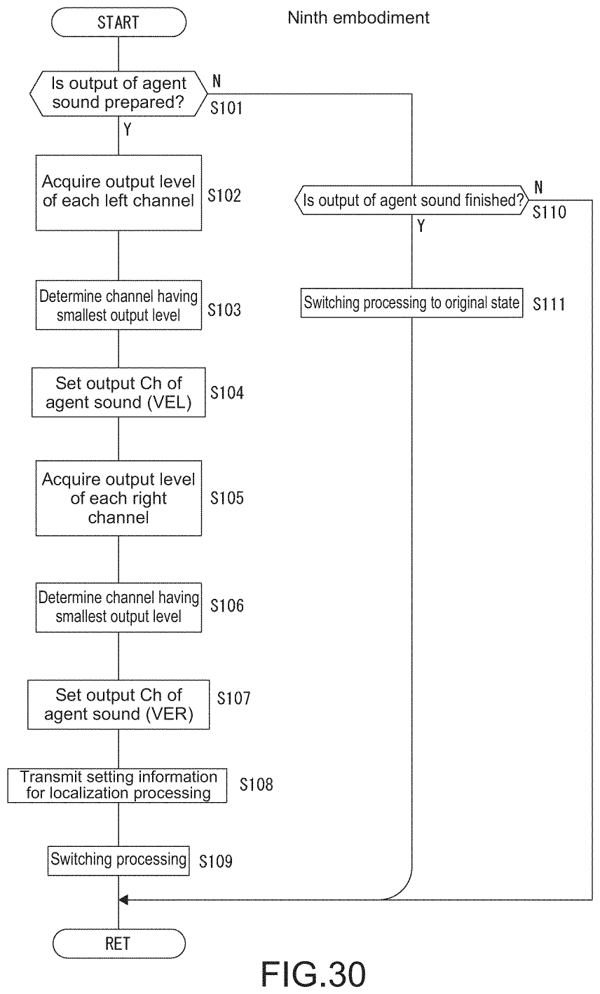

FIG. 30 shows a selection processing example according to the ninth embodiment. FIG. 30 shows, for example, the processing of the channel selection unit 46.

In Step S101, the channel selection unit 46 determines whether or not it is a timing for preparing an output of the agent sound. For example, the channel selection unit 46 recognizes the timing for preparing the output by the control signal CNT from the sound/localization processing unit 45.

This timing for preparing the output is a timing immediately before the output of the agent sound is started.

When the timing for preparing the output is detected, the channel selection unit 46 acquires the output level of each left channel in Step S102. Specifically, they are sound signal levels of the sound signals Sch1, Sch4, and Sch7. The signal levels to be acquired may be signal values at that time, but a certain amount of moving average value or the like is always detected, and the moving average value at that time may be obtained at the timing for preparing the output.

The channel selection unit 46 determines the channel having the smallest output level (signal level) in Step S103, and sets the determined channel as the channel used as the L (left) channel of the agent sound (sound signal VEL) in Step S104.

In addition, the channel selection unit 46 acquires each output level of the right channel in Step S105. Specifically, they are the sound signal levels of the sound signals Sch3, Sch6, and Sch9. Then, the channel selection unit 46 determines the channel having the smallest power level (signal level) in Step S106, and sets the determined channel as the channel used as the R (right) channel of the agent sound (sound signal VER) in Step S107.

In Step S108, the channel selection unit 46 notifies the sound/localization processing unit 45 of left and right channel information set for the agent sound. This is because the agent sound is always output at a specific constant location regardless of the selection of the speaker unit.

The sound/localization processing unit 45 changes parameter setting of the localization processing depending on the selection of the channel selection unit 46, so that the virtual speaker location becomes a constant location regardless of the change in the speaker location.

In Step S109, the channel selecting unit 46 performs switching of a signal path corresponding to the above setting. For example, if the sound signals Sch1 and Sch9 are in the smallest signal level on the respective left and right sides, the signal path is switched such that the sound signal VEL is supplied to the output unit 61 and the sound signal VER is supplied to the output unit 69.

In Step S110, the channel selection unit 46 monitors a timing at which the output of the agent sound is finished. This is also determined on the basis of the control signal CNT.

When it is the timing at which the output of the agent sound is finished, the signal path is returned to an original state of the signal path in Step S111. That is, the respective sound signals Sch1 to Sch9 are supplied from the output unit 61 to the output unit 69.

Through the above processing, in a case where the agent sound is output, the speaker unit with a low output is selected from the left side and the right side, and the speaker unit is switched to the speaker unit for the agent sound.

It should be noted that in this instance, the center speaker unit, i.e., the vibration regions AR2, AR5, and AR8 are not selected for the agent sound. This prevents a main sound from being difficult to hear in the content sound.

### 14. Tenth Embodiment

The tenth embodiment is an example in which the center speaker unit is also included and may be selected for the agent sound. However, the sound based on the sound signals VEL and VER as the agent sound is always output in a left-right positional relationship.

Also in this case, the configuration of the sound processing unit 24 is as shown in the example of FIG. 27.

However, the channel selection unit 46 is configured to be able to execute the sound output based on the sound signal VEL as the agent sound in any of the vibration regions AR1, AR2, AR4, AR5, AR7, and AR8 on the left side and the center of the screen, and to execute the sound output based on the sound signal VER as the agent sound in any of the vibration regions AR2, AR3, AR5, AR6, AR8, and AR9 on the center and the right side of the screen.

That is, the channel selection unit has a configuration that allows selection of the sound signal Sch1 and the sound signal VEL as the signals to be supplied to the output unit 61, allows selection of the sound signal Sch4 and the sound signal VEL as the signals to be supplied to the output unit 64, and allows selection of the sound signal Sch7 and the sound signal VEL as the signals to be supplied to the output unit 67.

In addition, the channel selection unit has a configuration that allows selection of the sound signal Sch3 and the sound signal VER as the signals to be supplied to the output unit 63, allows selection of the sound signal Sch6 and the sound signal VER as the signals to be supplied to the output unit 66, and allows selection of the sound signal Sch9 and the sound signal VER as the signals to be supplied to the output unit 69.

Furthermore, the channel selection unit 46 has a configuration that allows selection of the sound signal Sch2, the sound signal VEL, and the sound signal VER as the signals to be supplied to the output unit 62, allows selection of the sound signal Sch5, the sound signal VEL, and the sound signal VER as the signals to be supplied to the output unit 65, and allows selection of the sound signal Sch8, the sound signal VEL, and the sound signal VER as the signals to be supplied to the output unit 68.

With such a configuration, for example, the speaker unit selection as shown in FIG. 29 is performed.

However, since the left and right speaker units for the agent sound are selected while the center speaker unit is also used, the following selection variations occur.

That is, there is a possibility that each of the combinations listed below is selected as the left and right speaker units.

The vibration regions AR1 and AR2, the vibration regions AR1 and AR3, the vibration regions AR1 and AR5, the vibration regions AR1 and AR6, the vibration regions AR1 and AR8, the vibration regions AR1 and AR9, the vibration regions AR2 and AR3, the vibration regions AR2 and AR6, the vibration regions AR2 and AR9, the vibration regions AR4 and AR2, the vibration region AR4 and AR3, the vibration regions AR4 and AR5, the vibration regions AR4 and AR6, the vibration regions AR4 and AR8, the vibration regions AR4 and AR9, the vibration regions AR5 and AR3, the vibration regions AR5 and AR6, the vibration regions AR5 and AR9, the vibration regions AR7 and AR2, the vibration regions AR7 and AR3, the vibration regions AR7 and AR5, the vibration regions AR7 and AR6, the vibration regions AR7 and AR8, the vibration regions AR7 and AR9, the vibration regions AR8 and AR3, the vibration regions AR8 and AR6, and the vibration regions AR8 and AR9.

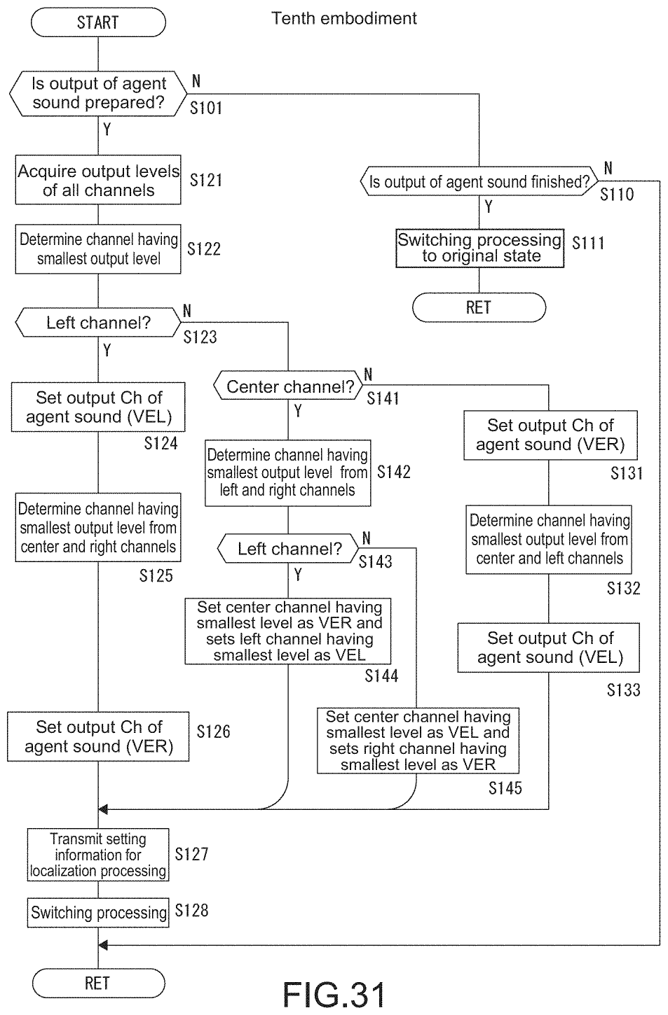

FIG. 31 shows a selection processing example for performing such selection. FIG. 31 shows, for example, the processing by the channel selection unit.

In Step S101, the channel selection unit 46 determines whether or not it is the timing for preparing the output of the agent sound similar to the example of FIG. 30.

When the timing for preparing the output is detected, the channel selection unit 46 acquires output levels of all channels in Step S121.

In Step S122, the channel selection unit 46 determines the channel having the smallest output level (signal level) among all the channels.

The determined channel branches the processing in any of the left channel, the center channel, and the right channel.

In a case where the channel determined as having the smallest signal level is any of the sound signal Sch1, Sch4, and Sch7 of the left channel, the channel selection unit 46 proceeds from Step S123 to S124 and sets the determined channel as the channel used for the sound signal VEL of the agent sound.

Then, the channel selection unit 46 determines the channel having the smallest output level (signal level) of the center and right channels (sound signal Sch2, Sch3, Sch5, Sch6, Sch8, and Sch9) in Step S125, and sets the determined channel as the channel used for the sound signal VER of the agent sound in Step S126.

In Step S127, the channel selection unit 46 notifies the sound/localization processing unit 45 of information of the left and right channels set for the localization processing.

Then, the channel selection unit 46 performs switching of the signal path corresponding to the channel setting in Step S128.

Furthermore, in a case where the channel determined in Step S122 is any of the sound signals Sch2, Sch5, and Sch8 that is the center channel, the channel selection unit 46 proceeds from Steps S141 to S142, and determines the channel having the smallest output level (signal level) from the left and right channels (sound signal Sch1, Sch3, Sch4, Sch6, Sch7, and Sch9).

If the determined channel is the left channel, it proceeds from Step S143 to Step S144, and the channel selection unit 46 sets the center channel having the smallest level as the channel used for the sound signal VER of the agent sound, and sets the left channel having the smallest level as the channel used for the sound signal VEL of the agent sound.

Then, the processing in Steps S127 and S128 is performed.

If the channel determined in Step S142 is the right channel, it proceeds from Step S143 to S145, and the channel selection unit 46 sets the center channel having the smallest level as the channel used for the sound signal VEL of the agent sound, and sets the right channel having the smallest level as the channel used for the sound signal VER of the agent sound.

Then, the processing in Steps S127 and S128 is performed.

If the channel is determined to have the smallest signal level in Step S122 is any of the sound signal Sch3, Sch6, and Sch9 of the right channel, the channel selection unit 46 proceeds to Step S131 and sets the determined channel as the channel used for the sound signal VER of the agent sound.

Then, the channel selection unit 46 determines the channel having the smallest output level (signal level) from the center and left channels (sound signals Sch1, Sch2, Sch4, Sch5, Sch7, and Sch8) in Step S132, and sets the determined channel as the channel used for the sound signal VEL of the agent sound in Step S133.

Then, the processing in Steps 5127 and 5128 is performed.

In Step S110, the channel selection unit 46 monitors the timing at which the output of the agent sound is finished. This is also determined on the basis of the control signal CNT.

When it is the timing at which the output of the agent sound is finished, the signal path is returned to the original state of the signal path in Step S111. That is, the respective sound signals Sch1 to Sch9 are supplied from the output unit 61 to the output unit 69.

Through the above processing, in a case where the agent sound is output, the speaker unit for the agent sound is selected in a state in which the positional relationship between the left and right is maintained, while the speaker unit with low output is selected for all the channels.

### 15. Summary and Modifications

In the above embodiments, the following effects are obtained.

The television apparatus 2 according to the embodiment includes the panel unit 110 for displaying the video content, one or more first actuators 121 (first sound output driving units) for executing the sound reproduction by vibrating the panel unit 110 on the basis of the first sound signal of the video content to be displayed by the panel unit 110, and the plurality of actuators 121 (second sound output driving units) for executing the sound reproduction by vibrating the panel unit 110 on the basis of the second sound signal different from the first sound signal. In addition, the television apparatus 2 includes the sound/localization processing unit 45 (localization processing unit) for setting the localization of the sound output by the plurality of second sound output driving units by the signal processing for the second sound signal.

In this case, when the agent sound by at least the second sound signal is output, the agent sound is reproduced by the actuator 121 (second sound output driving unit) separate from the actuator 121 (first sound output driving unit) used for outputting the content sound. Furthermore, the agent sound is heard by the user in a state where the agent sound is localized at a certain location by the localization processing.

As a result, the user can easily hear the difference between the content sound and the agent sound. Therefore, it is possible to accurately hear and understand the agent sound during television viewing and hearing or the like.

Incidentally, even if the localization processing for localizing the sound to the virtual predetermined location is not performed, since the actuator 121 is used independently for the content sound and the agent sound, sound generation locations on the panel unit 110 are different, so that the user can easily hear the difference between the content sound and the agent sound.

Furthermore, in the embodiments, the description is made taking the example of the content sound and the agent sound, but the second sound signal is not limited to the agent sound. For example, it may be a guide sound of the television apparatus 2, or a sound from other sound output device (audio device, information processing apparatus, or the like).

In each embodiment, the plurality of actuators 121 are provided as the first sound output driving units for reproducing the content sound, but only one actuator 121 may be used.

On the other hand, it is appropriate that there are two or more actuators 121 as the second sound output driving units for reproducing the agent sound in order to localize the agent sound to a desired location.

However, it is also conceivable to output the agent sound by using only one actuator 121. For example, by outputting the agent sound using one set of the vibration region AR and the actuator 121 in the corner of the screen, it is possible to make the user feel a localization state different from the content sound to some extent.

In the first, second, fourth, fifth, seventh, eighth, ninth, and tenth embodiments, it describes the example in which the panel part 110 is divided into the plurality of vibration regions AR which vibrate independently, and all the actuators 121 which are the first sound output driving units or the second sound output driving units are arranged one by one for each vibration region AR.

Thus, each vibration region AR is vibrated by each one actuator 121. That is, each vibration region AR will function as an each independent speaker unit. As a result, each output sound is clearly output, and both the content sound and the agent sound can be easily heard.

In addition, since the agent sound can be output without being influenced by the content sound, it is easy to accurately localize at the virtual speaker location.

In the case of the third and sixth embodiments, the plurality of actuators 121 are arranged in one vibration region AR, and the degree of the effect is reduced, but even in such a case, since at least the actuators 121 are different between the agent sound and the content sound, the localization control can be realized more easily and accurately than the localization control of the agent sound by the signal processing alone.

In each embodiment, as an example of the second sound signal, the agent sound, that is, the sound signal of the response sound generated corresponding to the request of the user is given.

By targeting the agent sound as described above, it is possible to improve usability in a case where an agent system is incorporated in the television apparatus 2.

In the embodiment, an example is described in which the sound/localization processing unit 45 performs the localization processing to localize the sound by the second sound signal at a location outside an image display surface range of the panel unit 110.

That is, for the user, the agent sound is heard from the virtual speaker location outside the display surface range of the panel unit 110 in which the video display is performed.

This allows the user to clearly separate the agent sound from the content sound, making it very easy to hear.

Furthermore, it is desirable that the virtual speaker location is always kept at a constant location. For example, the virtual speaker location set in the localization processing is always an upper left location of the television apparatus 2. Then, the user can recognize that the agent sound is always heard from the upper left of the television apparatus 2, and recognition of the agent sound is enhanced.

Note that the virtual speaker location may be selected by the user. For example, it is assumed that the virtual speaker location desired by the user can be realized by changing parameters of the localization processing of the sound/localization processing unit 45 depending on the operation of the user.

In addition, the virtual speaker location is not limited to the location outside the panel, it may be a predetermined location corresponding to the front surface of the panel unit 110.

In the first, second, third, fourth, and fifth embodiments, it describes the example in which specific actuators 121 are the second sound output driving units (for agent sound) among the plurality of actuators 121 arranged on the panel unit 110.

Among the plurality of actuators 121 arranged on the panel unit 110, the specific actuator 121 (e.g., actuator 121AL, 121AR of FIG. 12, etc.) is used as the sound output driving unit for the agent sound. By providing the dedicated actuator 121 for the agent sound in this manner, the configurations of the sound signal processing unit 24 and the sound output unit 25 can be simplified.

In addition, since the agent sound is always output by the same vibration regions AR (for example, vibration regions AR3 and AR4 in the cases of FIGS. 12, 13, and 14), the localization processing of the sound/localization processing unit 45 does not need to be dynamically changed, thereby reducing a processing burden.

Note that among the actuators 121 arranged on the panel unit 110, any actuator 121 may be used for the agent sound. For example, if two actuators 121 spaced left and right and two actuators 121 spaced up and down are provided for the agent sound, it is appropriate in that they are localized in the virtual speaker location.

In the first, second, fourth, and fifth embodiments, it describes the example in which the panel unit 110 is divided into the plurality of vibration regions AR that vibrate independently, and the second sound output driving units are arranged on the vibration regions AR other than each vibration region including a center of the panel unit 110. Note that the center of the panel unit 110 does not need to be a strict center point, and may be near the center.

The vibration region AR located at the center of the screen serves to reproduce the content sound. Generally, the center sound is the main sound of the content sound. Therefore, by outputting the content sound using the center vibration region AR, it is possible to form a good content viewing and hearing environment for the user. For example, in the examples of FIG. 14A, FIG. 14B, FIG. 14C, FIG. 16A, and FIG. 16B, the vibration region including the center of the panel unit 110 is the vibration regions AR1 and AR2. In the examples of FIG. 19A, FIG. 19B, FIG. 19C, FIG. 20A, FIG. 20B, and FIG. 20C, the vibration region including the center of the panel unit 110 is the vibration region AR3. These vibration regions AR are used for the content sound.

On the other hand, since the agent sound realizes the localization at the virtual speaker location, it is not necessary to use the center vibration region AR.

Incidentally, even without being localized in the virtual speaker location to be outside a display region of the panel unit 110, it is preferable to output the agent sound by the vibration region AR of the location biased up and down and left and right of the panel unit 110. That is, the content sound caused by the center vibration region AR is hardly interfered, and the agent sound can be clearly and easily heard by the user.

In the first, second, fourth, and fifth embodiments, it describes the example in which the panel unit 110 is divided into the plurality of vibration regions AR that vibrate independently, and the second sound output driving units are arranged for the respective two vibration regions AR at least located in the left and right directions of the display panel.

That is, the two vibration regions AR, which are arranged so as to be at least the left-right positional relationship, are each driven by an actuator 121 for the agent sound.

By applying the two vibration regions AR arranged in the left-right positional relationship to the reproduction of the agent sound, it is possible to easily set the virtual speaker location in the left and right directions (horizontal direction).

In the second and fifth embodiments, it describes the example in which the panel unit 110 is divided into the plurality of vibration regions AR that vibrate independently, and the second sound output driving units are arranged on the respective two vibration regions located at least in the up and down directions of the display panel.

That is, the two vibration regions AR, which are arranged so as to have at least an up-and-down positional relationship, are each driven by an actuator 121 for the agent sound.

By applying the two vibration regions AR arranged in the up-and-down positional relationship to the reproduction of the agent sound, it is possible to easily set the virtual speaker location in the up and down directions (vertical direction).

Furthermore, for example, by making the three or more vibration regions AR having an up-down and left-right positional relationship to output the agent sound in each actuator 121, it is possible to more flexibly set the virtual speaker location. For example, in FIGS. 16 and 20, the four vibration regions AR are used for the agent sound, and, in this case, it is easy to select the virtual speaker location on a virtual plane extending from the display surface of the panel unit 110.

In the seventh, eighth, ninth, and tenth embodiments, the panel unit 110 is divided into the plurality of vibration regions AR that vibrate independently, and the actuator 121 is provided for each vibration region AR. When the sound output based on the second sound signal is not performed, all of the actuators 121 are used as the first sound output driving units. Some of the actuators 121 are used as the second sound output driving units in a case where the sound output based on the second sound signal is performed.

That is, some of the actuators 121 and the vibration regions AR are used for switching between the content sound and the agent sound.

When only the content sound is reproduced, by using all the vibration regions AR, the sound output utilizing the sound reproduction capability of the panel unit 110 including the plurality of actuators 121. For example, it is possible to reproduce sounds with higher volume and power.

On the other hand, when the agent sound is reproduced, it can be dealt with by switching and using some of the vibration regions AR.

Noted that the embodiment shows the example in which the vibration region AR is divided into nine, but, needless to say, it is not limited to nine divisions. For example, 4 divisions, 6 divisions, 8 divisions, 12 divisions, and the like are also assumed. In each case, it is also conceivable that which vibration region AR is switched and used for the agent sound.

Also, in the example of FIG. 22, each vibration region AR has the same shape and area, but the vibration regions AR having different areas and shapes may be provided.

In addition, the vibration region AR and the actuator 121 used for switching and using the agent sound may be used for reproducing a virtual signal of the content sound, except when the agent sound is output.

In the seventh and eighth embodiments, the actuator 121 for the vibration region AR other than the vibration region including the center of the panel unit 110 is switched and used between the content sound and the agent sound.

The vibration region AR located at the center of the screen is always allocated to the reproduction of the content sound. Since the content sound has the main sound of the center sound, by outputting the content sound by always using the center vibration region AR, it is possible to form a content viewing and hearing environment in which the user feels less uncomfortable even at the time of outputting the agent sound.

On the other hand, since the agent sound realizes the localization at the virtual speaker location, it is not necessary to use the center vibration region AR, and the other vibration region AR is switched to a content sound application.

In the ninth and tenth embodiments, it describes the example in which the processing of selecting the actuator 121 to be used for the agent sound is performed when the agent sound is output.

That is, when only the content sound is reproduced, all the sets of the actuators 121 and the vibration regions AR are used for the content sound output. On the other hand, when the agent sound is output, for example, two sets of the plurality of actuators 121 are selected. This allows to output the agent sound using appropriate sets of the actuators 121 and vibration regions AR depending on the situation.

The selection may be based on elements other than a sound output level. For example, it is also conceivable to select depending on the environmental conditions around the television apparatus 2, the location of an audience, the number of people, and the like.

In the ninth and tenth embodiments, it describes the example in which in a case where the agent sound is output, the sound output level is detected by the plurality of actuators 121, and the actuator 121 (channel) used for the agent sound is selected depending on the output level of each actuator 121.

That is, the set to be switched and used for the agent sound is selected from the plurality of sets of the vibration regions AR and the actuators 121 depending on the output state at that time.

As a result, for example, the actuator 121 having a small output level is selected, and the agent sound can be output in a state in which the reproduction of the content sound is less affected.

Incidentally, the actuator 121 having a large volume level may be selected. This is because it may make it easier to hear the agent sound by reducing the volume of the content sound.

In the ninth embodiment, it describes the example in which the sound output level is detected for the actuator 121 for the vibration region AR other than the vibration region including the center of the panel unit 110, and the actuator 121 (channel) for the agent sound is selected depending on the detected output level.

As a result, the center vibration region AR is not used for the agent sound. Therefore, it is possible to output the agent sound in a state in which the reproduction of the content sound is less affected.

According to the technology of the embodiments, it is possible to construct a system in which the agent sound can be easily heard in consideration of the content reproduction by the television apparatus 2.

Needless to say, the technology of the embodiment can be applied to devices other than the television apparatus 2 as described above.

Note that the effects described herein are merely illustrative and not restrictive, and may have other effects.

Note that the present technology may also have the following configurations.
(1)

A sound output apparatus, including a display panel for displaying video content;

one or more first sound output driving units for vibrating the display panel on the basis of a first sound signal which is a sound signal of the video content displayed on the display panel and for executing sound reproduction;

a plurality of second sound output driving units for vibrating the display panel on the basis of a second sound signal different from the first sound signal and for executing the sound reproduction; and

a localization processing unit for setting a constant location of a sound output by the plurality of second sound output driving units by signal processing of the second sound signal.
(2)

The sound output apparatus according to (1), in which

the display panel is divided into a plurality of vibration regions that vibrate independently, and

the sound output driving units that are the first sound output driving units or the second sound output driving units are arranged one by one for each vibration region.
(3)

The sound output apparatus according to (1) or (2), in which

the second sound signal is a sound signal of a response sound generated corresponding to a request.
(4)

The sound output apparatus according to any of (1) to (3), in which

the localization processing unit performs localization processing for localizing the sound by the second sound signal to a location outside a display surface range of the display panel.
(5)

The sound output apparatus according to any of (1) or (4), in which

specific sound output driving units among the plurality of sound output driving units arranged on the display panel are the second sound output driving units.
(6)

The sound output apparatus according to any of (1) or (5), in which

the display panel is divided into the plurality of vibration regions that vibrate independently, and the second sound output driving units are arranged on the vibration regions other than each vibration region including a center of the display panel.
(7)

The sound output apparatus according to any of (1) or (6), in which

the display panel is divided into the plurality of vibration regions that vibrate independently, and

the respective second sound output driving units are arranged on two vibration regions at least located in the left and right directions of the display panel.
(8)

The sound output apparatus according to any of (1) or (7), in which

the display panel is divided into the plurality of vibration regions that vibrate independently, and

the respective second sound output driving units are arranged on two vibration regions at least located in the up and down directions of the display panel.
(9)

The sound output apparatus according to any of (1) or (4), in which

the display panel is divided into the plurality of vibration regions that vibrate independently,

the sound output driving units are provided for the respective vibration regions,

in a case where a sound output based on the second sound signal is not performed, all the sound output driving units are used as the first sound output driving units, and

in a case where the sound output based on the second sound signal is performed, parts of the sound output driving units are used as the second sound output driving units.
(10)

The sound output apparatus according to (9) in which

the sound output driving units on the vibration regions other than each vibration region including a center of the display panel are parts of the sound output driving units.
(11)

The sound output apparatus according to (9), in which

in a case where a reproduced sound by the second sound signal is output, processing of selecting the sound output driving units used as the second sound output driving units is performed.
(12)

The sound output apparatus according to (9) or (11), in which

in a case where the reproduced sound by the second sound signal is output, detection of a sound output level is performed by the plurality of sound output driving units, and the sound output driving units used as the second sound output driving units are selected depending on the output level of each sound output driving unit.
(13)

The sound output apparatus according to (12), in which

in relation to the sound output driving units on the vibration regions other than each vibration region including a center of the display panel, detection of the sound output level is performed and the sound output driving units to be used as the second sound output driving units are selected depending on the detected output level.
(14)

The sound output apparatus according to any of (1) or (13), which is a built-in television apparatus.
(15) A sound output method, including:

executing sound reproduction by vibrating a display panel with one or more first sound output driving units on the basis of a first sound signal which is a sound signal of video content to be displayed on the display panel for displaying the video content;

performing signal processing for setting a constant location on a second sound signal different from the first sound signal; and

executing sound reproduction by vibrating the display panel by a plurality of second sound output driving units for the second sound signal.

### REFERENCE SIGNS LIST

1 agent apparatus
2 television apparatus
3 network
4 microphone
5 speaker
6 analysis engine
10 sound recognition unit
11 natural language understanding unit
12 action unit
13 sound synthesis unit
15 calculation unit
17 memory unit
18 sound input unit
21 antenna
22 tuner
23 demultiplexer
24 sound processing unit
25 sound processing unit
26 video processing unit
27 video output unit
31 display unit
32 control unit
33 memory
v34 input unit
36 network communication unit
41 L sound processing unit
42 R sound processing unit
43 center sound processing unit
44L, 44R mixer
45 agent sound/localization processing unit
46 channel selection unit
47, 48 switch
49 multichannel processing unit
51 L output unit
52 R output unit
53 center output unit
54, 55, 56, 57 agent sound output unit
60, 61, 62, 63, 64, 65, 66, 67, 68, 69 output unit
70 input management unit
71 analysis information acquisition unit
110 panel unit
120 vibration unit 121, 121a, 121b, 121cm 121L, 121R, 121AL, 121AR, 121AL1, 121AR1, 121AL2, 121AR2, 121-1, 121-2, 121-3, 121-4, 121-5, 121-6, 121-7, 121-8, 121-9 actuator (vibrator)
AR, AR1, AR2, AR3, AR4, AR5, AR6, AR7, AR8, AR9 vibration region

1. A sound output apparatus, comprising:
a display panel for displaying video content;
one or more first sound output driving units for vibrating the display panel on a basis of a first sound signal which is a sound signal of the video content displayed on the display panel and for executing sound reproduction;
a plurality of second sound output driving units for vibrating the display panel on a basis of a second sound signal different from the first sound signal and for executing the sound reproduction; and
a localization processing unit for setting a constant location of a sound output by the plurality of second sound output driving units by signal processing of the second sound signal.

2. The sound output apparatus according to claim 1, wherein
the display panel is divided into a plurality of vibration regions that vibrate independently, and
the sound output driving units that are the first sound output driving units or the second sound output driving units are arranged one by one for each vibration region.

3. The sound output apparatus according to claim 1, wherein
the second sound signal is a sound signal of a response sound generated corresponding to a request.

4. The sound output apparatus according to claim 1, wherein
the localization processing unit performs localization processing for localizing the sound by the second sound signal to a location outside a display surface range of the display panel.

5. The sound output apparatus according to claim 1, wherein
specific sound output driving units among the plurality of sound output driving units arranged on the display panel are the second sound output driving units.

6. The sound output apparatus according to claim 1, wherein
the display panel is divided into a plurality of vibration regions that vibrate independently, and
the second sound output driving units are arranged on the vibration regions other than each vibration region including a center of the display panel.

7. The sound output apparatus according to claim 1, wherein
the display panel is divided into a plurality of vibration regions that vibrate independently, and
the respective second sound output driving units are arranged on two vibration regions at least located in left and right directions of the display panel.

8. The sound output apparatus according to claim 1, wherein
the display panel is divided into a plurality of vibration regions that vibrate independently, and
the respective second sound output driving units are arranged on two vibration regions at least located in up and down directions of the display panel.

9. The sound output apparatus according to claim 1, wherein
the display panel is divided into a plurality of vibration regions that vibrate independently,
the sound output driving units are provided for the respective vibration region,
in a case where a sound output based on the second sound signal is not performed, all the sound output driving units are used as the first sound output driving units, and
in a case where the sound output based on the second sound signal is performed, parts of the sound output driving units are used as the second sound output driving units.

10. The sound output apparatus according to claim 9, wherein
the sound output driving units on the vibration regions other than each vibration region including a center of the display panel are the parts of the sound output driving units.

11. The sound output apparatus according to claim 9, wherein
in a case where a reproduced sound by the second sound signal is output, processing of selecting the sound output driving units used as the second sound output driving units is performed.

12. The sound output apparatus according to claim 9, wherein
in a case where a reproduced sound by the second sound signal is output, detection of a sound output level is performed by the plurality of sound output driving units, and the sound output driving units used as the second sound output driving units are selected depending on the output level of each sound output driving unit.

13. The sound output apparatus according to claim 12, wherein
in relation to the sound output driving units on the vibration regions other than each vibration region including a center of the display panel, detection of the sound output level is performed and the sound output driving units to be used as the second sound output driving units are selected depending on the detected output level.

14. The sound output apparatus according to claim 1, which is a built-in television apparatus.

15. A sound output method, comprising:
executing sound reproduction by vibrating a display panel with one or more first sound output driving units on a basis of a first sound signal which is a sound signal of video content to be displayed on the display panel for displaying the video content;
performing signal processing for setting a constant location on a second sound signal different from the first sound signal; and
executing sound reproduction by vibrating the display panel by a plurality of second sound output driving units for the second sound signal.
